(19) United States
(12) Patent Application Publication
(10) Pub. No.: US 2016/0196156 A1
(43) Pub. Date: Jul. 7, 2016

(54) SIMULATION APPARATUS, SIMULATION METHOD, AND COMPUTER PRODUCT

(71) Applicant: FUJITSU LIMITED, Kawasaki-shi (JP)

(72) Inventors: Shinya KUWAMURA, Kawasaki (JP); Atsushi Ike, Minato (JP)

(73) Assignee: FUJITSU LIMITED, Kawasaki-shi (JP)

(21) Appl. No.: 15/070,230

(22) Filed: Mar. 15, 2016

Related U.S. Application Data
(63) Continuation of application No. PCT/JP2014/062444, filed on May 9, 2014.

(30) Foreign Application Priority Data
Sep. 24, 2013 (JP) 2013-197621

(51) Int. Cl. G06F 9/455

(52) U.S. Cl. CPC G06F 9/45516

(57) ABSTRACT

A simulation apparatus includes a generating circuit configured to detect an internal state of a processor at a start of execution of a process block, when among blocks obtained by dividing code of a program executed by the processor that performs out-of-order execution, processing transitions to the process block in a simulation simulating operation in a case where the processor executes the program, the generating circuit being further configured to generate host code that enables calculation of a block execution period for the case where the processor executes the process block, the generating circuit generating the host code by executing the simulation of the process block based on the detected internal state of the processor; and an executing circuit configured to calculate the block execution period by executing the host code generated by the generating circuit.

### CROSS REFERENCE TO RELATED APPLICATIONS

This is a continuation application of International Application PCT/JP2014/062444 filed on May 9, 2014 which claims priority from a Japanese Patent Application No. 2013-197621 filed on Sep. 24, 2013, the contents of which are incorporated herein by reference.

### FIELD

The embodiments discussed herein are related to a simulation apparatus, a simulation method, and a computer product.

### BACKGROUND

With systems becoming more complicated and multicore configurations where multiple processors (e.g., CPUs) are equipped being standard, core (CPU) function and performance simulation processing that realizes higher processing speed and processing accuracy is demanded. In simulating function, performance, etc., the adoption of an interpreter scheme or just-in-time (JIT) compiler scheme as a translation technique of translating a target CPU subject to evaluation, from instruction code (target code) of the target CPU for a case of operation by a host CPU, to instruction code (host code) of the host CPU is known.

In simulation by a JIT compiler scheme, an instruction of the target CPU appearing in a program under execution and subject to simulation is replaced with an instruction of the host CPU that executes the simulation and thereafter, the instruction of the host CPU is executed. Accordingly, JIT compiler scheme processing is faster compared to interpreter scheme processing and in CPU function simulation, when high speed is particularly required, a JIT compiler scheme is adopted. For example, refer to David Thach, et al, “Fast Cycle Estimation Methodology for Instruction-Level Emulator”, EDAA, 2012, ISBN:978-3-9810801-8-6.

Nonetheless, with the conventional techniques, when a JIT compiler scheme is adopted in performance simulation for an out-of-order execution processor, a problem arises in that the accuracy of the performance simulation decreases. For example, at an out-of-order execution processor, the extent to which an instruction affects performance increases and the accuracy of performance simulation decreases consequent to out-of-order execution of the instruction.

### SUMMARY

According to an aspect of an embodiment, a simulation apparatus includes a generating circuit configured to detect an internal state of a processor at a start of execution of a process block, when among blocks obtained by dividing code of a program executed by the processor that performs out-of-order execution, processing transitions to the process block in a simulation simulating operation in a case where the processor executes the program, the generating circuit being further configured to generate host code that enables calculation of a block execution period for the case where the processor executes the process block, the generating circuit generating the host code by executing the simulation of the process block based on the detected internal state of the processor; and an executing circuit configured to calculate the block execution period by executing the host code generated by the generating circuit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram depicting an example of a simulation method according to a first embodiment;

FIG. 2 is a block diagram depicting an example of hardware configuration of a simulation apparatus 100;

FIG. 3 is a block diagram depicting an example of a functional configuration of the simulation apparatus 100;

FIG. 4 is a diagram depicting an example of the contents stored by a host code list 400;

FIGS. 5A and 5B are diagrams depicting examples where timing code is embedded;

FIG. 6 is a block diagram depicting an example of configuration of a target CPU;

FIG. 7 is a diagram depicting an example of target code;

FIGS. 8, 9, 10, 11, 12, 13, 14, and 15 are diagrams depicting examples of changes of an internal state of the target CPU;

FIG. 16 is a diagram depicting a detailed example of host code hc;

FIG. 17 is a diagram depicting an example of the target code;

FIG. 18 is a diagram depicting an example of the host code hc;

FIGS. 19, 20, 21, and 22 are diagrams depicting an example of changes in the internal state of the target CPU;

FIG. 23 is a diagram depicting processing operation of a correcting unit 322;

FIGS. 24A, 24B, and 24C are diagrams of an example of correcting LD instruction execution results;

FIGS. 25A, 25B, and 25C are diagrams of an example of correcting LD instruction execution results;

FIGS. 26A, 26B, and 26C are diagrams of an example of correcting LD instruction execution results;

FIG. 27 is a flowchart of an example of a process procedure by a code translating unit 310;

FIG. 28 is a flowchart of an example of a process procedure by a simulation executing unit 320;

FIG. 29 is a flowchart of an example of a process procedure by a correcting unit 322;

FIG. 30 is a diagram depicting an example of changes in a state of an instruction queue in the target CPU;

FIG. 31 is a diagram depicting an example of target code;

FIG. 32 is a diagram depicting an example of changes in the internal state of the target CPU;

FIG. 33 is a diagram depicting an example of the contents stored by the host code list 400;

FIG. 34 is a diagram depicting an example of generation of resource utilization information;

FIG. 35 is a flowchart of an example of the process procedure by the code translating unit 310 of the simulation apparatus 100 according to the second embodiment;

FIG. 36 is a flowchart of an example of the process procedure by the simulation executing unit 320 of the simulation apparatus 100 according to a second embodiment;

FIG. 37 is a diagram depicting a detailed example of the host code hc;

FIG. 38 is a flowchart of an example of the process procedure by the code translating unit 310 of the simulation apparatus 100 according to a third embodiment;

FIG. 39 is a flowchart of an example of the process procedure by the code translating unit 310 of the simulation apparatus 100 according to a fourth embodiment; and

FIG. 40 is a flowchart of an example of the process procedure by the simulation executing unit 320 of the simulation apparatus 100 according to the fourth embodiment.

### DESCRIPTION OF EMBODIMENTS

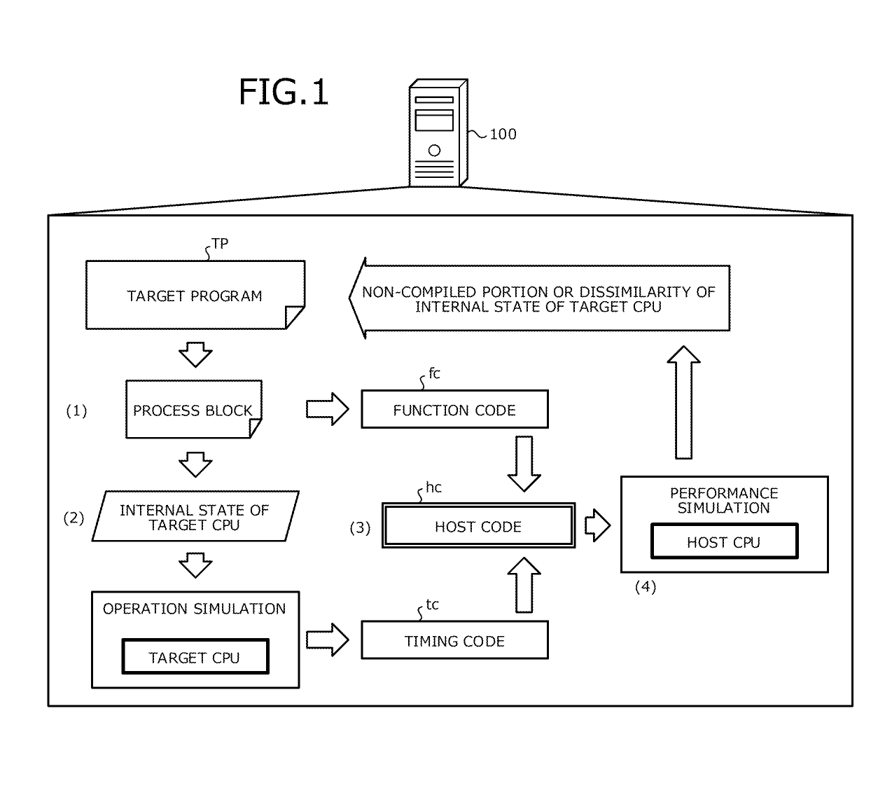

FIG. 1 is a diagram depicting an example of a simulation method according to a first embodiment. In FIG. 1, a simulation apparatus 100 is a computer that executes performance simulation of an out-of-order execution processor. Here, out-of-order execution is a technique for improving instruction execution efficiency of a processor, and a technique of executing an instruction for which data necessary for processing has been obtained, irrespective of the instruction sequence described in the program. Further, performance simulation is simulation that estimates an execution period (e.g., a cycle count) for a case where the processor executes the program.

In the description hereinafter, an out-of-order execution processor subject to performance evaluation may be indicated as “target central processing unit (CPU)”; and the processor of the simulation apparatus 100 may be indicated as “host CPU”. Further, a program executed by a target CPU maybe indicated as “target program TP”.

The target CPU, for example, is a processor of ARM (registered trademark) architecture. The host CPU, for example, is a processor of x86 architecture. In other words, the architecture of the target CPU and the host CPU differ. Therefore, the simulation apparatus 100, when performing simulation by the host CPU, translates the target program TP of the target CPU to code executable by the host CPU.

In the present embodiment, a JIT compiler scheme is adopted as a translation technique for the target program TP. In simulation by the JIT compiler scheme, an instruction of the target CPU appearing in a program under execution is replaced by an instruction of the host CPU executing the simulation and thereafter, the instruction of the host CPU is executed, enabling faster processing to be facilitated.

More specifically, for example, the simulation apparatus 100, at the time of execution of the target program TP of the target CPU, separates and divides the code of the target program TP into given blocks B. Next, the simulation apparatus 100 generates for each resulting block B, host code hc executable by the host CPU. The simulation apparatus 100, by executing the generated host code hc, estimates the execution period for a case where the target CPU executes the block B.

The host code hc is code executable by the host CPU and includes function code fc and timing code tc. The function code fc is code executable by the host CPU, obtained by compiling the blocks B divided from the target program TP. The timing code tc is code enabling the host CPU to calculate the execution period for a case where the target CPU executes the block B.

Here, at the out-of-order execution target CPU, an instruction for which the data necessary for processing has been obtained is executed irrespective of the instruction sequence described in the target program TP. Therefore, there may be cases where consequent to an out-of-order execution of the instruction, the internal state of the target CPU when the target CPU starts execution of the blocks B differs.

The internal state of the target CPU represents the state of a module that the target CPU has for realizing out-of-order execution. For example, the internal state of the target CPU is the address of an instruction executed immediately before the block under processing, the state of an instruction queue of the target CPU, the state of an execution unit, the state of a reorder buffer, etc.

The instruction queue is a storage area that temporarily saves a decoded instruction. The execution unit is a module that executes each instruction such as an arithmetic logic unit (ALU), a load/store unit, and a branching unit. The reorder buffer is a storage area that temporarily saves a decoded instruction, and for each stored instruction, has information indicating a state of awaiting execution or completion.

When the internal state of the target CPU differs, the execution sequence of the instructions in the block B changes and therefore, even for the same block B, the execution period of the block B may differ depending on the internal state of the target CPU. In other words, the internal state of the target CPU is information that affects the execution period (performance value) of an instruction. For example, when the execution period of a block B in a case where the instructions in the block B are executed in the sequence described in the target program TP, an execution period that is slow compared to an actual chip (target CPU) that sequentially performs execution from an instruction for which the data necessary for processing has been obtained may be estimated.

Thus, in the present embodiment, based on the internal state of the target CPU, the simulation apparatus 100 performs operation simulation simulating operation for a case where the target CPU executes the target program TP. The simulation apparatus 100 generates based on simulation results of the operation simulation, host code hc that can calculate the execution period for a case where the target CPU executes the blocks B. As a result, a performance value of high accuracy can be estimated for the target CPU, taking into consideration the instruction execution sequence, which changes depending on the internal state of the target CPU. Hereinafter, an example of processing by the simulation apparatus 100 will be described.

(1) The simulation apparatus 100 separates and divides the code of the target program TP executed by the target CPU into given blocks B. The block unit into which the code is divided may be, for example, a basic (fundamental) block unit or a predetermined arbitrary code unit. A basic block is code having one entrance and one exit, and including no branching code internally.

(2) After transition to a new process block among the blocks B obtained by dividing the code of the target program TP, the simulation apparatus 100 detects the internal state of the target CPU when execution of the process block is started in operation simulation.

Here, a process block is a block B that is subject to processing in performance simulation and operation simulation. Further, operation simulation is simulation simulating operation for a case where the target CPU executes the target program TP.

Operation simulation, for example, is executed by providing the target program TP to a model of a system that has the target CPU and hardware resources accessible by the target CPU. A behavior model that reproduces only a function of the system by hardware description language, etc. can be used as a model of the system.

For example, information (e.g., execution start time and execution period) indicating the execution timing of each instruction of the process block is output as simulation results. However, when a process block is in a state where the execution of an instruction has not finished, the execution period of the instruction at that time point is output.

Further, the internal state of the target CPU, for example, in operation simulation, is the contents stored in the instruction queue of the target CPU at the time of completion of the block B executed immediately before the process block, an instruction input to the execution unit, the contents stored in the reorder buffer, etc. In other words, the simulation apparatus 100 detects as the internal state of the target CPU at the start of execution of the process block, the internal state of the target CPU at the completion of execution of the block B executed immediately before the process block.

(3) The simulation apparatus 100 executes based on the detected internal state of the target CPU, operation simulation of the process block and thereby, generates host code hc that can calculate the execution period for a case where the target CPU executes the process block. More specifically, for example, first, the simulation apparatus 100 compiles the target code of the process block and thereby, generates host code hc (only function code fc) executable by the host CPU.

Next, the simulation apparatus 100 executes based on the detected internal state of the target CPU, operation simulation of the process block. More specifically, for example, based on the state of the execution units and the reorder buffer, and the instruction queue of the target CPU at the time of completion of the block B executed immediately before the process block, the simulation apparatus 100 simulates according to the specifications of the target CPU, progress of the execution of instructions included in the process block.

The simulation apparatus 100 generates based on simulation results of the operation simulation for the process block, timing code tc that calculates the execution period for a case where the target CPU executes the process block. The simulation apparatus 100 embeds the timing code tc into the host code hc for only the function code fc and thereby, generates host code hc for the process block.

Here, the simulation apparatus 100, for example, associates and records the process block, the host code hc of the process block and the internal state of the target CPU at the start of execution of the process block, and the internal state of the target CPU at the time of completion of the execution of the process block. As a result, the host code hc of the process block and the internal state of the target CPU at the start of execution of the process block can be identified. Further, the internal state of the target CPU at the completion of execution of the process block can be identified as the internal state of the target CPU at the start of execution of a block B that is to be executed subsequent to the process block.

(4) The simulation apparatus 100 executes the host code hc generated for the process block and thereby, calculates the execution period for a case where the target CPU executes the process block. As a result, the execution period for a case where the target CPU executes the process block can be estimated.

In this manner, according to the simulation apparatus 100 of the first embodiment, the execution period of a process block can be obtained with consideration of the instruction execution sequence, which changes according to the internal state of the target CPU. As a result, the accuracy of the performance estimation for the target CPU, which performs out-of-order execution from an instruction for which data necessary for processing has been obtained, can be improved.

Further, configuration may be such that after transition to a new process block, the simulation apparatus 100 determines whether the process block is a block previously subject to processing. As a result, whether the process block is a non-compiled portion for which function code fc has not been generated can be determined.

Further, configuration may be such that when the process block is a block previously subject to processing, the simulation apparatus 100 determines whether the detected internal state of the target CPU is identical to the internal state of the target CPU detected when the process block was previously subject to processing. In this case, if the internal state of the target CPU is not identical, the simulation apparatus 100 generates host code hc for the process block.

If the internal state of the target CPU is identical, the simulation apparatus 100 does not generate host code hc for the process block. Further, configuration may be such that if the internal state of the target CPU is identical, the simulation apparatus 100 executes the host code hc generated when the process block was previously subject to processing and thereby, calculates the execution period of the process block.

As a result, repeated generation of the same host code hc for a given block B can be prevented and increases in the amount of memory used for the performance simulation of the target CPU can be suppressed. Further, processing that repeatedly generates the same host code hc can be curtailed, enabling faster performance simulation to be facilitated.

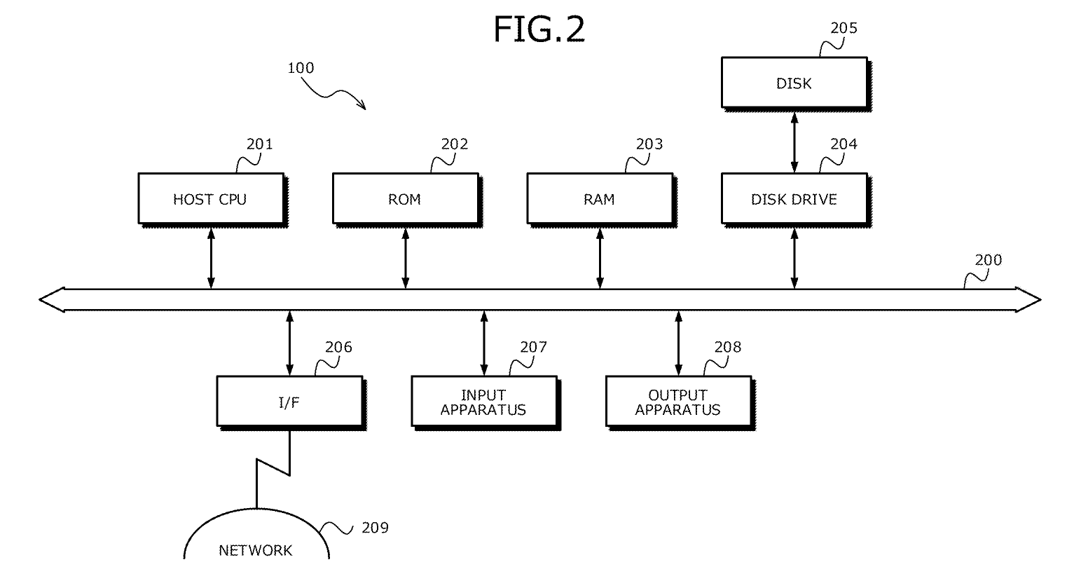

FIG. 2 is a block diagram depicting an example of hardware configuration of the simulation apparatus 100. In FIG. 2, the simulation apparatus 100 has a CPU 201, read-only memory (ROM) 202, random access memory (RAM) 203, a disk drive 204, and a disk 20. The simulation apparatus 100 further has an interface (I/F) 206, an input apparatus 207, and an output apparatus 208. The components are connected by a bus 200, respectively.

Here, the CPU 201 governs overall control of the simulation apparatus 100. The CPU 201 is further the host CPU that executes performance simulation of the target CPU. The ROM 202 stores a program such as a boot program. The RAM 203 is a storage unit used as a work area of the CPU 201. The disk drive 204, under the control of the CPU 201, controls the reading and writing of data with respect to the disk 205. The disk 205 stores data written thereto under the control of the disk drive 204. A magnetic disk, an optical disk, and the like may be used as the disk 205.

The I/F 206 is connected to a network 209 such as a local area network (LAN), a wide area network (WAN), the Internet, etc. through a communications line and is connected to another computer via the network 209. The I/F 206 administers an internal interface with the network 209 and controls the input and output of data from other computers. The I/F 206, for example, can be a modem, a LAN adapter, and the like.

The input apparatus 207 is an interface that inputs various types of data by user input via a keyboard, mouse, touch panel, etc. The output apparatus 208 is an interface that outputs data according to an instruction of the CPU 201. The output apparatus 208 may be a display, a printer, etc.

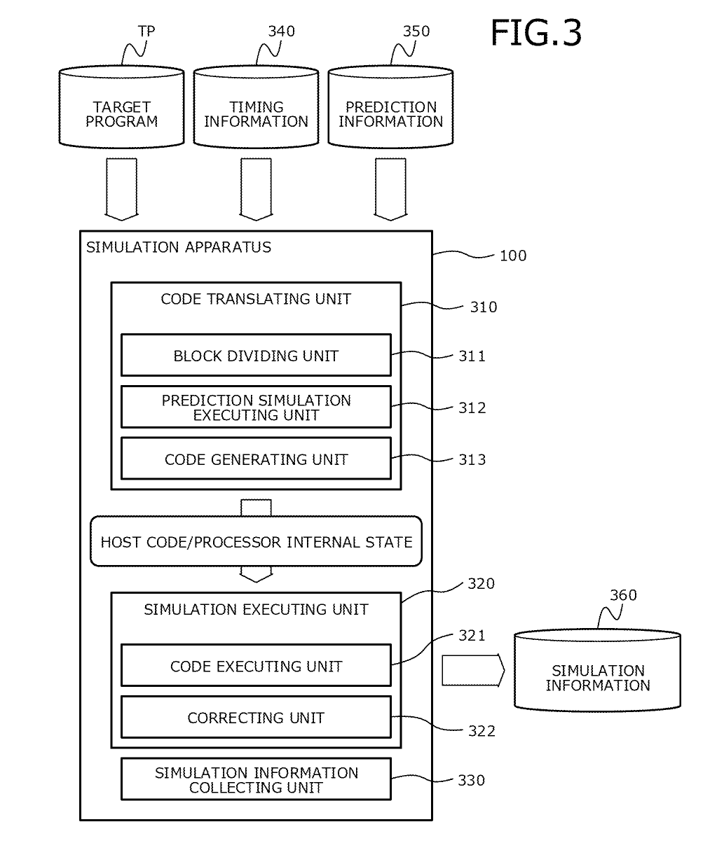

FIG. 3 is a block diagram depicting an example of a functional configuration of the simulation apparatus 100. In FIG. 3, the simulation apparatus 100 has a code translating unit 310, a simulation executing unit 320, and a simulation information collecting unit 330. The code translating unit 310, the simulation executing unit 320, and the simulation information collecting unit 330 are functions forming a control unit and more specifically, for example, are functions realized by executing on the CPU 201, a program stored in a storage apparatus such as the ROM 202, the RAM 203, and the disk 205 depicted in FIG. 2, or by the I/F 206. Processing results of each functional unit, for example, is stored to a storage apparatus such as the RAM 203, the disk 205, etc.

Here, the simulation apparatus 100 receives input of the target program TP, timing information 340 related to the target program TP, and prediction information 350. More specifically, for example, the simulation apparatus 100 receives input of the target program TP, the timing information 340, and the prediction information 350 by user operation of the input apparatus 207 depicted in FIG. 2.

The target program TP is a program executed by the target CPU subject to performance evaluation. The simulation apparatus 100 estimates the execution period for a case where the target CPU executes the target program TP. Further, the timing information 340 is information that for each instruction of the target code, indicates a reference value of the execution period when the instruction is executed and for each externally dependent instruction among the instructions, a penalty period (penalty cycle count) defining a delay period according to the execution result. An externally dependent instruction is an instruction for which the execution period changes and is dependent on the state of hardware resources accessed by the target CPU at the time of execution of the instruction.

For example, an externally dependent instruction is an instruction such as a load instruction, a store instruction, etc. for which the execution result of the instruction changes depending on the state of instruction cache, data cache, a translation lookaside buffer (TLB), etc.; an instruction that performs processing such as branch prediction, call/return stacking, etc. Further, the timing information 340, for example, may include for each instruction of the target code, information indicating correspondence of an available register and each process element (step) at the time of execution of the instruction.

Further, the prediction information 350 is information defining an execution result (predicted result) having a high probability of occurring in the processing of an externally dependent instruction of the target code. In the prediction information 350, for example, “instruction cache:prediction=hit, data cache:prediction=hit, TLB search:prediction=hit, branch prediction:prediction=hit, call/return:prediction=hit, . . . ”, etc. is defined.

The code translating unit 310, at the time of execution of the target program TP, generates code (host code) for the host CPU from the code (target code) of the target program TP executed by the target CPU. More specifically, the code translating unit 310 includes a block dividing unit 311, a prediction simulation executing unit 312, and a code generating unit 313.

The block dividing unit 311 separates and divides the target code of the target program TP into given blocks B. More specifically, for example, the block dividing unit 311 divides the target program TP into given blocks B by separating the target program TP at a branch instruction and the branch destination of the branch instruction.

Concerning the timing at which the block dividing unit 311 divides the code of the target program TP into the blocks B, the block dividing unit 311 may divide all the code in advance, or may divide the code at each transition to a new process block.

The prediction simulation executing unit 312 executes operation simulation simulating operation for a case where the target CPU executes the target program TP. For example, after transition to a new process block, the prediction simulation executing unit 312 detects the internal state of the target CPU at the start of execution of the process block in the operation simulation.

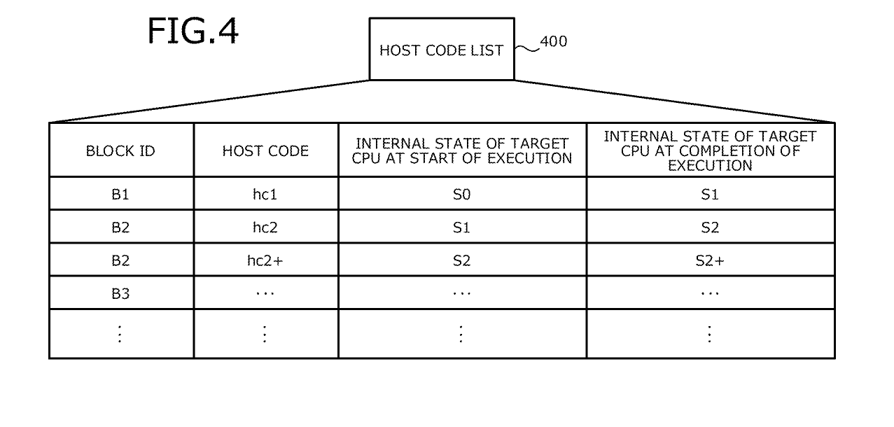

More specifically, for example, the prediction simulation executing unit 312 obtains from a host code list 400 depicted in FIG. 4 described hereinafter, the internal state of the target CPU at the completion of execution of the block B executed immediately before the process block, as the internal state of the target CPU at the start of execution of the process block.

However, when the process block is the first block B to be executed, the internal state at the start of execution of the process block is an initial state. The initial state can be arbitrarily set and, for example, is a state where the instruction queue and the reorder buffer of the target CPU are empty and no instruction has been input to an execution unit.

Next, the prediction simulation executing unit 312, based on the detected internal state of the target CPU, executes operation simulation of the process block. More specifically, for example, the prediction simulation executing unit 312, based on the timing information 340 and the prediction information 350, performs operation simulation of executing the process block, under conditions assuming a given execution result.

More specifically, for example, based on the prediction information 350, the prediction simulation executing unit 312 sets the predicted result of an externally dependent instruction included in the process block. Based on the detected internal state of the target CPU, the prediction simulation executing unit 312 references the timing information 340, executes the instruction for a case (predicted case) assuming a set predicted result, and simulates progress of the execution of the instruction.

Here, taking a load instruction (may be indicated as “LD instruction” hereinafter) as an example, in the case of processing where “cache hit” is set as a predicted result for an LD instruction, the prediction simulation executing unit 312 simulates execution of processing for a case where cache access results in “hit” for an LD instruction in the process block.

Further, the prediction simulation executing unit 312 outputs as simulation results, for example, an execution start time and execution period (there may be cases where execution is not finished) for each instruction of the process block. Further, the prediction simulation executing unit 312, for example, records into the host code list 400 (refer to FIG. 4), the internal state of the target CPU at the point in time when simulation concerning the process block is completed.

More specifically, for example, the prediction simulation executing unit 312 associates and records into the host code list 400 (refer to FIG. 4), a block ID identifying the process block and the internal state of the target CPU at the start of execution of the process block and the internal state of the target CPU at the completion of execution of the process block. Although details will be described hereinafter, execution of the process block, for example, ends when all of the instructions of the process block are stored in the instruction queue of the target CPU.

The code generating unit 313, based on the simulation results obtained by the prediction simulation executing unit 312, generates host code hc that can calculate the execution period for a case where the target CPU executes the process block. Here, host code hc is code executable by the host CPU and includes the function code fc and the timing code tc.

More specifically, for example, the code generating unit 313 compiles the target code of the process block and thereby, generates the host code hc executable by the host CPU (only the function code fc). The code generating unit 313, based on the simulation results, further generates and embeds into the host code hc (only the function code fc), timing code tc that can calculate the execution period for a case where the target CPU executes the process block.

More specifically, for example, the code generating unit 313 obtains the execution period of the LD instruction in the predicted case, and for a case where cache access results in “miss” for the LD instruction, generates host code hc that obtains the execution period by correction calculation using addition/subtraction with respect to the execution period when “hit” is the predicted case. As a result, host code hc can be generated that can calculate the execution period for a case where the target CPU executes the process block.

Further, the code generating unit 313, for example, associates and records into the host code list 400 (refer to FIG. 4), a block ID identifying the process block and the host code hc generated for the process block. Here, the contents stored in the host code list 400 will be described. The host code list 400, for example, is realized by a storage apparatus such as the RAM 203 and the disk 205 depicted in FIG. 2.

FIG. 4 is a diagram depicting an example of the contents stored by the host code list 400. In FIG. 4, the host code list 400 associates and stores a block ID, host code, the internal state of the target CPU at the start of execution, and the internal state of the target CPU at the completion of execution.

Here, the block ID is an identifier of a block B obtained by dividing the target code. The host code is the host code hc of the block B. The internal state of the target CPU at the start of execution is the internal state of the target CPU at the start of execution of the block B in operation simulation. The internal state of the target CPU at the completion of execution is the internal state of the target CPU at the completion of execution of the block B in the operation simulation.

In the example depicted in FIG. 4, host code hc1 of block B1, an internal state S0 of the target CPU at the start of execution of block B1, and an internal state S1 of the target CPU at the completion of execution of block B1 are associated and stored in the host code list 400. The internal state S0 is the initial state.

Further, host code hc2 of block B2, an internal state S1 of the target CPU at the start of execution of block B2, and an internal state S2 of the target CPU at the completion of execution of block B2 are associated and stored. Further, host code hc2+ of block B2, the internal state S2 of the target CPU at the start of execution of block B2, and an internal state S2+ of the target CPU at the completion of execution of block B2 are associated and stored.

Although not depicted, to divert use of the host code hc (only the function code fc) of the process block, the code generating unit 313 may associate and record into the host code list 400, a block ID of the process block and the host code hc (only function code fc) of the process block.

Here, description of FIG. 3 is continued. The simulation executing unit 320 executes the host code hc generated by the code generating unit 313 and thereby, calculates the execution period for a case where the target CPU executes the process block. In other words, the simulation executing unit 320 performs performance and function simulation concerning instruction execution of the target CPU executing the target program TP.

More specifically, the simulation executing unit 320 includes a code executing unit 321 and a correcting unit 322. The code executing unit 321 executes the host code hc of a process block. More specifically, for example, the code executing unit 321, from the host code list 400, obtains the host code hc that corresponds to the block ID of the process block and executes the obtained host code hc.

When the host code hc of the process block is executed, the next process block B is specified and information (e.g., block ID) of this block B is output to the code translating unit 310. As a result, the code translating unit 310 can recognize transition to a new process block in performance simulation and can recognize the next process block in the operation simulation.

When the execution result of an externally dependent instruction differs from the set predicted result (a case other than the predicted case), the correcting unit 322 obtains the execution period of the instruction by correcting the execution period of an already obtained predicted case. More specifically, for example, the correcting unit 322 executes operation simulation simulating operation for a case of the target CPU executing the target program TP and thereby, determines whether the execution result of the externally dependent instruction differs from the set predicted result.

The operation simulation, for example, is executed by providing the target program TP to a model of a system having the target CPU and hardware resources accessible to the target CPU such as cache.

The correcting unit 322 uses the penalty period imposed by the externally dependent instruction, the execution periods of the instructions executed before and after the externally dependent instruction, the delay period of the instruction immediately before, etc. to perform correction. Details of a correction process by the correcting unit 322 will be described hereinafter with reference to FIGS. 24 to 26.

The simulation information collecting unit 330 collects as execution results of performance simulation, log information (simulation information 360) that includes the execution period of each block B. More specifically, for example, configuration may be such that the simulation information collecting unit 330 adds the execution periods of the blocks B and thereby, outputs the simulation information 360 to include the overall execution period for a case where the target CPU executes the target program TP.

Further, after transition to a new process block, the prediction simulation executing unit 312 determines whether the process block is a block previously subject to processing. More specifically, for example, the prediction simulation executing unit 312 references the host code list 400 depicted in FIG. 4 and determines whether the block ID of the process block is registered.

If the block ID of the process block is registered, the prediction simulation executing unit 312 determines that the process block is a block previously subject to processing. On the other hand, if the block ID of the process block is not registered, the prediction simulation executing unit 312 determines that the process block is not a block previously subject to processing.

Here, when the process block is not a block previously subject to processing, the prediction simulation executing unit 312 executes based on the detected internal state of the target CPU at the start of execution of the process block, operation simulation of the process block. Further, the code generating unit 313 generates based on simulation results obtained by the prediction simulation executing unit 312, host code hc for the process block.

The prediction simulation executing unit 312, when determining that the process block is a block previously subject to processing, determines whether the detected internal state of the target CPU at the start of execution of the process block is identical to the internal state of the target CPU detected at the start of execution of the block when the block was previously subject to processing.

More specifically, for example, the prediction simulation executing unit 312 references the host code list 400 and determines whether the detected internal state of the target CPU at the start of execution of the process block is identical to the stored internal state of the target CPU at the start of execution, associated with the block ID of the process block.

Here, when the internal state of the target CPU is not identical, the prediction simulation executing unit 312 executes operation simulation of the process block, based on the detected internal state of the target CPU at the start of execution of the process block. Further, the code generating unit 313 generates host code hc for the process block, based on the simulation results obtained by the prediction simulation executing unit 312.

On the other hand, when the internal state of the target CPU is identical, the prediction simulation executing unit 312 does not execute operation simulation of the process block. Further, the code generating unit 313 does not generate host code hc for the process block. In other words, if the internal states of the target CPU at the start of execution are identical, the host code hc generated when the process block was previously subject to processing can be reused and therefore, the code generating unit 313 does not generate host code hc for the process block.

Further, when the detected internal state of the target CPU is the internal state of the target CPU detected when the process block was previously subject to processing, the code executing unit 321 executes the host code hc generated when the process block was previously subject to processing.

Here, a JIT compiling phase by the code translating unit 310 and an execution phase by the simulation executing unit 320 will be described.

At the JIT compiling phase, 1. operation simulation based on the internal state of the target CPU and prediction is performed. 2. Host code hc for the process block is generated. 3. The internal state of the target CPU and the host code hc are recorded.

At the execution phase, 1. The host code hc of the process block is executed. 2. A helper function is executed at necessary locations. A helper function is a function for calling the correction process of correcting the execution period of an externally dependent instruction. The helper function will be described in detail hereinafter. 3. Whether the prediction is correct is determined and if the prediction is not correct, correction is performed.

Transition from the execution phase to the JIT compiling phase occurs when a non-compiled portion (non-generated block of host code hc) is detected, or when dissimilarity of the internal states of the target CPU is detected.

One example of a process procedure at the JIT compiling phase is described. Input includes the target code and the internal state of the target CPU at the start of execution. Output includes host code hc of the process block and the internal state of the target CPU after execution. Further, 1. the target code is divided into blocks B. 2. An externally dependent instruction is detected. 3. For the instruction detected at 2., an execution result of high probability is set (predicted case). 4. Operation simulation by the internal state of the target CPU and predicted case is executed. 5. Based on the simulation result at 4., host code hc of the process block is generated for the predicted case and is recorded together with the internal state of the target CPU.

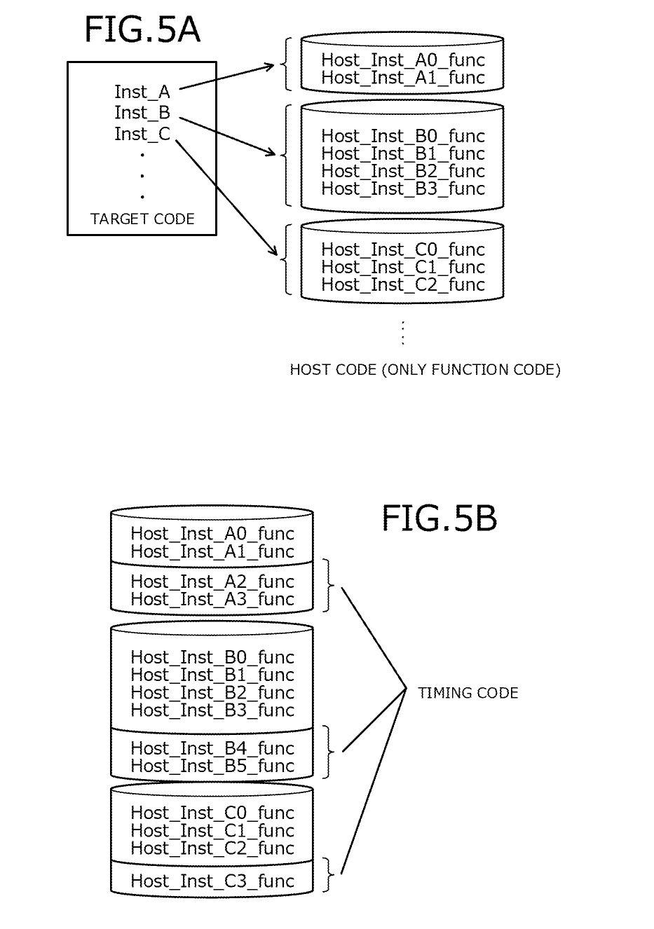

FIGS. 5A and 5B are diagrams depicting examples where timing code is embedded. FIG. 5A depicts an example where host code hc (only function code fc) is generated from the target code and FIG. 5B depicts an example where timing code tc is embedded in the host code hc (only function code fc).

As depicted in FIG. 5A, target code Inst_A is translated into host code Host_Inst_A0_func, Host_Inst_A1_func; target code Inst_B is translated into host code Host_Inst_B0_func, Host_Inst_B1_func, Host_Inst_B2_func, . . . ; and host code hc of only function code fc is generated.

Further, as depicted in FIG. 5B, in the host code hc of the function code fc only, timing code Host_Inst_A2_cycle, Host_Inst_A3_cycle of the target code Inst_A and timing code Host_Inst_B4_cycle, Host_Inst_B5_cycle of the target code Inst_B, etc. are embedded, respectively.

The timing code tc is code that makes the execution period (required cycle count) of an instruction included in a given block a constant, totals the execution periods of the instructions, and obtains a processing period of the process block. As a result, information that indicates the progress during block execution can be obtained. In the host code hc, function code fc and timing code tc for instructions other than externally dependent instructions can be implemented using known code. Timing code tc for externally dependent instructions is prepared as a helper function call instruction that calls the correction process. The helper function call instruction will be described hereinafter.

First, operation simulation for a case where the target CPU executes the target program TP will be described. In this example, an out-of-order execution processor that concurrently decodes two instructions is assumed as a specification of the target CPU. Further, the target CPU has a 4-stage pipeline (F-D-E-W).

At the F-stage, an instruction is obtained from memory. At the D-stage, the instruction is decoded, put into an instruction queue (IQ), and recorded into a reorder buffer (ROB). At the E-stage, among the instructions in the instruction queue, an instruction that has become executable is input to an execution unit, and after process completion by the execution unit, the state of the instruction of the reorder buffer is changed to “completed”. At the W-stage, completed instructions are deleted from the reorder buffer.

Further, the target CPU has as execution units, 2 ALUs, a load/store unit, and a branching unit. An execution cycle count (reference value) for each instruction at each execution unit can be arbitrarily set. For example, the execution cycle count is “2” when an MUL instruction is executed by an ALU; the execution cycle count is “0” when a branch instruction is executed by the branching unit; and the execution cycle count is “1” when any other instruction is executed by an execution unit.

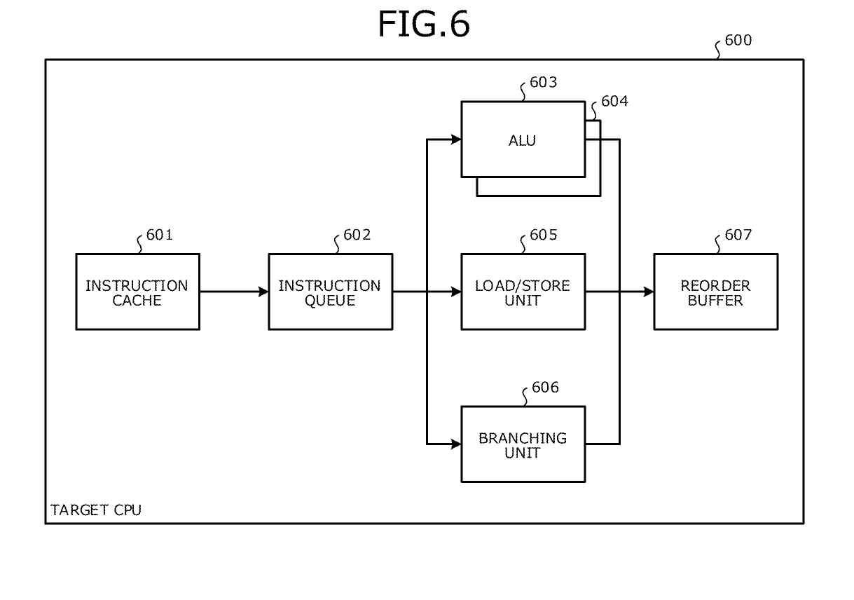

FIG. 6 is a block diagram depicting an example of configuration of the target CPU. In FIG. 6, a target CPU 600 includes an instruction cache 601, an instruction queue 602, ALUs 603, 604, a load/store unit 605, a branching unit 606, and a reorder buffer 607.

The instruction cache 601 stores an instruction obtained from memory (not depicted). The instruction queue 602 stores decoded instructions. The ALUs 603, 604 are execution units that perform arithmetic and logical computation such as MUL instructions, ADD instructions, etc. The load/store unit 605 is an execution unit that executes load/store instructions. The branching unit 606 is an execution unit that executes branch instructions. The reorder buffer 607 stores decoded instructions. Further, the reorder buffer 607 has information indicating a state of awaiting execution or completion for each stored instruction.

The prediction simulation executing unit 312, for example, executes operation simulation by providing the target program TP to a model such as the target CPU 600. Further, here, as a precondition of operation simulation, “hit” is set as the predicted case for each external factor. For example, “instruction cache:prediction=hit, data cache:prediction=hit, TLB search:prediction=hit, branch prediction:prediction=hit, call/return stack:prediction=hit” is set.

Input information includes target code of the process block and the internal state of the target CPU at the start of execution of the process block. Further, output information includes, for example, the execution start time and the execution period (there are also cases where execution is not finished) of each instruction of the process block, and the internal state of the target CPU at the time when execution of the process block is completed.

A main routine of operation simulation, for example, is as follows, where, at each clock cycle, each stage is assumed to be simulated. Further, the instruction at the F-stage is assumed to not stall and the F-stage is omitted.

1. cycle=0

2. end=false

3. while end==false

4. end=stage_d( )

5. stage_w( )

6. stage_e( )

7. cycle=cycle+1

8. return cycle

A subroutine of operation simulation, for example, is as follows.

stage_d( )

1. obtain instruction from process block

2. determine instruction type

3. record instruction into reorder buffer

4. put instruction into instruction cache

5. return true when instruction is last instruction of process block

6. when instruction is first instruction, return to 1.; when instruction is second instruction, return false (concurrent decoding of 2 instructions)

stage_w( )

delete completed instruction from head of reorder buffer

stage_e( )

for each execution unit, execute the following

1. If instruction is under execution, determine whether execution has been completed and if completed, clear instruction under execution, and set corresponding instruction in reorder buffer to state of completed

2. If no instruction is under execution, obtain instruction from instruction queue, and set state of execution unit to instruction under execution

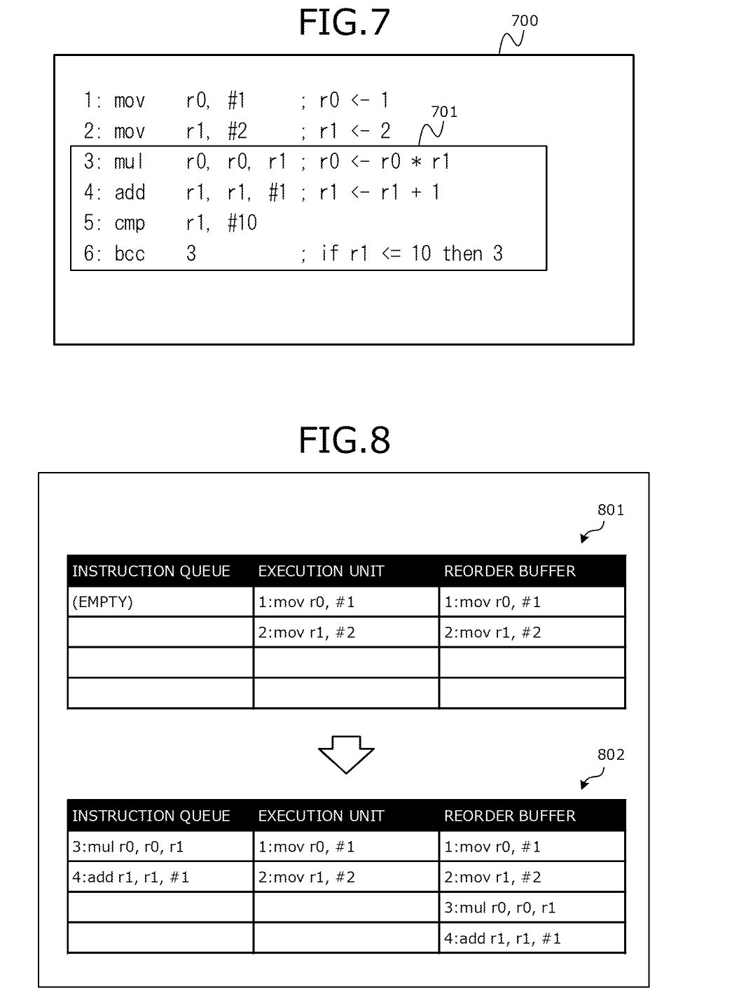

FIG. 7 is a diagram depicting an example of target code. In FIG. 7, target code 700 is code to obtain 1×2×3×4×5×6×7×8×9×10. In the target code 700, lines 1 and 2 are a block B of an initializing process and lines 3 to 6 are a block B of a loop.

The initializing process is a process that sets the initial value of r0 as “1”, and sets the initial value of r1 as “2”. The loop is a loop process that repeatedly performs a series of processes of setting the value of r0 as “r0*r1”, and incrementing the value of r1, until the value of r1 exceeds 10. Here, lines 3 to 6 are assumed to be a process block 701 and lines 1 and 2 are assumed to be the block B executed immediately before the process block 701.

Hereinafter, an example of operation simulation of the target CPU in a case where the target CPU 600 executes the target code 700 will be described with reference to FIGS. 8 to 15.

FIGS. 8, 9, 10, 11, 12, 13, 14, and 15 are diagrams depicting examples of changes of the internal state of the target CPU. In FIG. 8, an internal state 801 represents the internal state of the target CPU 600 at the start of execution of the process block 701 in the operation simulation. Here, instructions stored in the instruction queue 602, instructions input to execution units (the ALUs 603, 604, the load/store unit 605, the branching unit 606), and instructions stored in the reorder buffer 607 are depicted as the internal state of the target CPU 600.

In the internal state 801, the instruction queue 602 is empty; and instruction 1(mov r0,#1) and instruction 2(mov r1,#2) are input to execution units. Further, instruction 1(mov r0,#1) and instruction 2(mov r1,#2) are stored in the reorder buffer 607.

In the operation simulation, first, the prediction simulation executing unit 312 executes stage_d( )). An internal state 802 represents the internal state of the target CPU 600 after the execution of stage_d( ) (refer to FIG. 8).

In the internal state 802, instruction 3(mul r0,r0,r1) and instruction 4(add r1,r1,#1) are stored in the instruction queue 602; and instruction 1(mov r0,#1) and instruction 2(mov r1,#2) are input to execution units. Further, instruction 1(mov r0,#1), instruction 2(mov r1,#2), instruction 3(mul r0,r0,r1), and instruction 4(add r1,r1,#1) are stored in the reorder buffer 607.

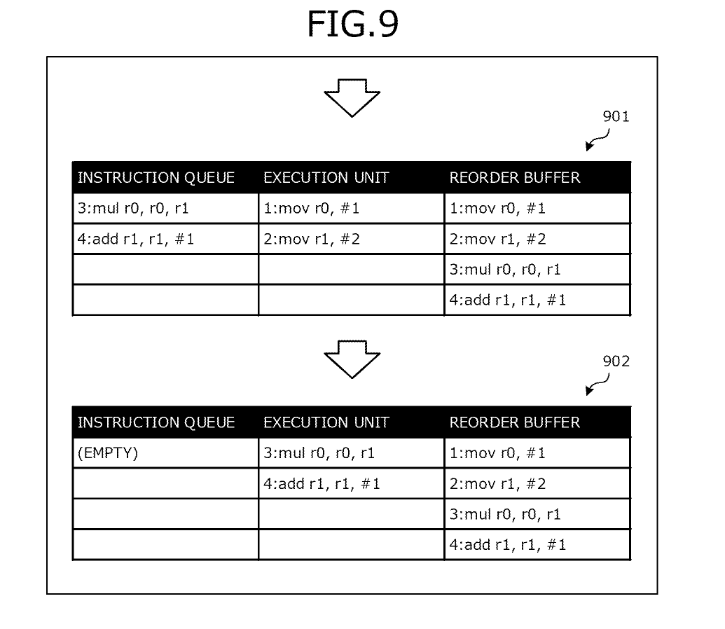

Next, in the operation simulation, the prediction simulation executing unit 312 executes stage_w( )). An internal state 901 represents the internal state of the target CPU 600 after the execution of stage_w( ) (refer to FIG. 9).

In the internal state 901, instruction 3(mul r0,r0,r1) and instruction 4(add r1,r1,#1) are stored in the instruction queue 602; and instruction 1(mov r0,#1) and instruction 2(mov r1,#2) are input to execution units. Further, instruction 1(mov r0,#1), instruction 2(mov r1,#2), instruction 3(mul r0,r0,r1), and instruction 4(add r1,r1,#1) are stored in the reorder buffer 607.

Here, since no completed instruction is present, the internal state of the target CPU 600 before and after stage_w( ) does not change.

Next, in the operation simulation, the prediction simulation executing unit 312 executes stage_e( ). As a result, the main routine loop has been executed one time. An internal state 902 represents the internal state of the target CPU 600 after the execution of stage_e( ) (refer to FIG. 9).

In the internal state 902, the instruction queue 602 is empty; and instruction 3(mul r0,r0,r1) and instruction 4(add r1,r1,#1) are input to execution units. Further, instruction 1(mov r0,#1), instruction 2(mov r1,#2), instruction 3(mul r0,r0,r1), and instruction 4(add r1,r1,#1) are stored in the reorder buffer 607.

Here, since the execution of instructions 1 and 2 by the execution units has been completed, instructions 1 and 2 are deleted from the execution units. Further, since the execution units are available, instructions 3 and 4 from the instruction queue 602 are input to the execution units.

The values of each variable (cycle, end) after one execution of the main routine loop are as follows.

cycle: 1

end: false

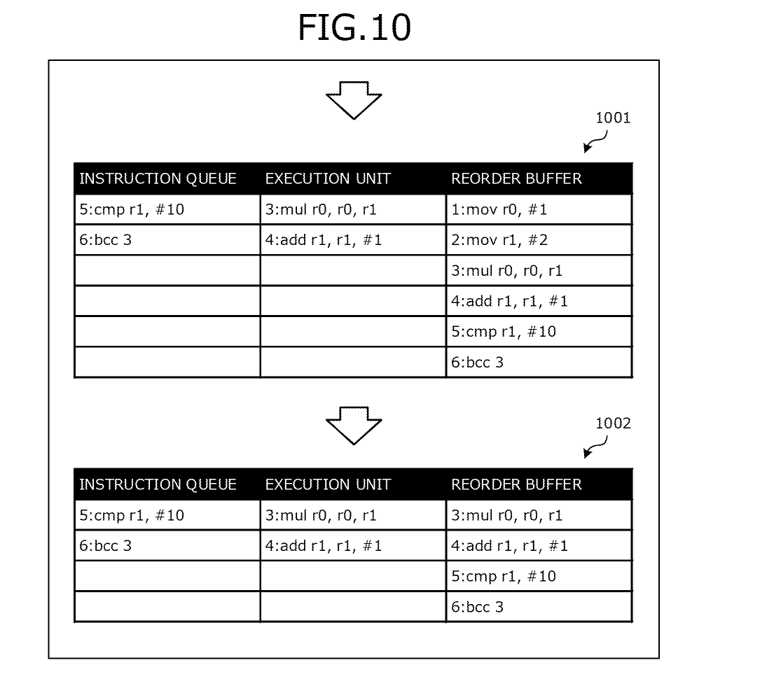

Next, in the operation simulation, the prediction simulation executing unit 312 executes stage_d( ) a second time. An internal state 1001 represents the internal state of the target CPU 600 after the execution of stage_d( ) the second time (refer to FIG. 10).

In the internal state 1001, instruction 5(cmp r1,#10) and instruction 6(bcc 3) are stored in the instruction queue 602; and instruction 3(mul r0,r0,r1) and instruction 4(add r1,r1,#1) are input to execution units. Further, instruction 1(mov r0,#1), instruction 2(mov r1,#2), instruction 3(mul r0,r0,r1), instruction 4(add r1,r1,#1), instruction 5(cmp r1,#10), and instruction 6(bcc 3) are stored in the reorder buffer 607.

Here, since instruction 6 is the last instruction of the process block 701, the value of the variable (end) becomes “true”.

Next, in the operation simulation, the prediction simulation executing unit 312 executes stage_w( ) a second time. An internal state 1002 represents the internal state of the target CPU 600 after the execution of stage_w( ) the second time (refer to FIG. 10).

In the internal state 1002, instruction 5(cmp r1,#10) and instruction 6(bcc 3) are stored in the instruction queue 602; and instruction 3(mul r0,r0,r1) and instruction 4(add r1,r1,#1) are input to execution units. Further, instruction 3(mul r0,r0,r1), instruction 4(add r1,r1,#1), instruction 5(cmp r1,#10), and instruction 6(bcc 3) are stored in the reorder buffer 607.

Here, since instructions 1 and 2 have been completed, instructions 1 and 2 are deleted from the reorder buffer 607.

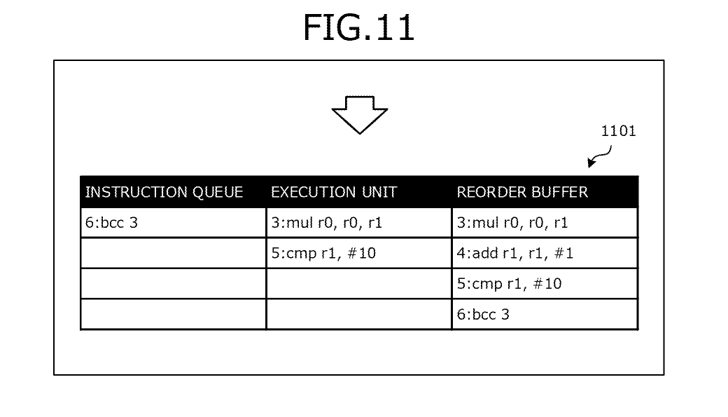

Next, in the operation simulation, the prediction simulation executing unit 312 executes stage_e( ) a second time. As a result, the main routine loop has been executed two times. An internal state 1101 represents the internal state of the target CPU 600 after the execution of stage_e( ) the second time (refer to FIG. 11).

In the internal state 1101, instruction 6(bcc 3) is stored in the instruction queue 602; and instruction 3(mul r0,r0,r1) and instruction 5(cmp r1,#10) are input to execution units. Further, instruction 3(mul r0,r0,r1), instruction 4(add r1,r1,#1), instruction 5(cmp r1,#10), and instruction 6(bcc 3) are stored in the reorder buffer 607.

Here, since execution of instruction 4 by an execution unit has been completed, instruction 4 is deleted from the execution unit. Since instruction 3 takes two cycles by the MUL instruction, the execution of instruction 3 has not finished. Further, since an ALU execution unit is available, instruction 5 from the instruction queue 602 is input to the execution unit. Further, since instruction 6 is dependent on instruction 5 and thus cannot be executed, instruction 6 remains the instruction queue 602, without being executed.

The values of each variable (cycle, end) after two executions of the main routine loop are as follows.

cycle: 2

end: true

Here, since the value of the variable (end) is “true”, the prediction simulation executing unit 312 returns simulation results indicating the execution period and the execution start time of executed instructions of the process block 701. As a result, in the operation simulation, execution of the process block 701 ends. Here, the prediction simulation executing unit 312 may return an execution cycle count “2” representing the execution period of the process block 701.

Further, since the last instruction 6 of the process block 701 is stored in the instruction queue 602, the process block in the operation simulation is changed. Here, by a branch instruction of line 6 of the target code 700, branch prediction assumes “hit” (predicted case), and processing returns to line 3, which is the branch destination, and the block B of lines 3 to 6 again becomes the process block.

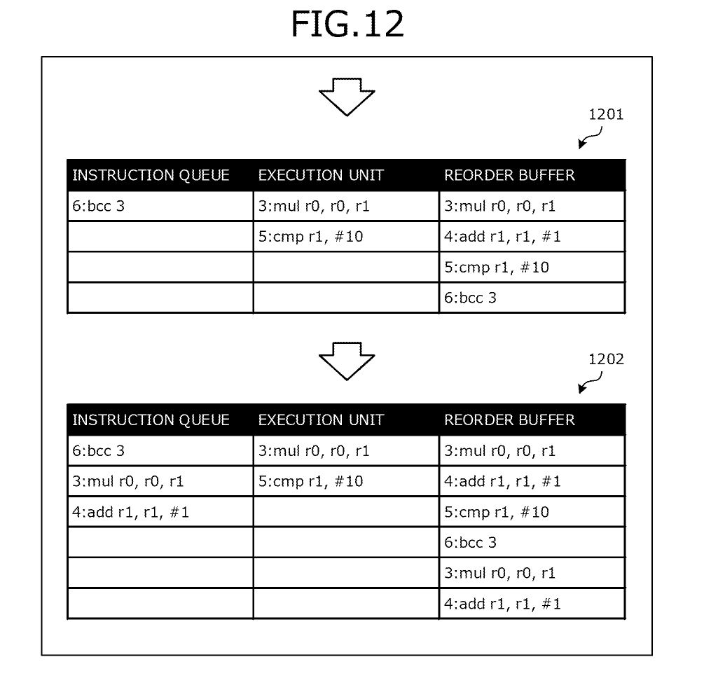

In FIG. 12, an internal state 1201 represents the internal state of the target CPU 600 at the start of execution of the process block 701 a second time in the operation simulation. The internal state 1201 is identical to the internal state 1101 at the completion of execution of the process block 701 the first time.

In the operation simulation, first, the prediction simulation executing unit 312 executes stage_d( ). An internal state 1202 represents the internal state of the target CPU 600 after the execution of stage_d( ) (refer to FIG. 12).

In the internal state 1202, instruction 6, instruction 3, and instruction 4 are stored in the instruction queue 602; and instruction 3 and instruction 5 are input to execution units. Further, instruction 3, instruction 4, instruction 5, instruction 6, instruction 3, and instruction 4 are stored in the reorder buffer 607.

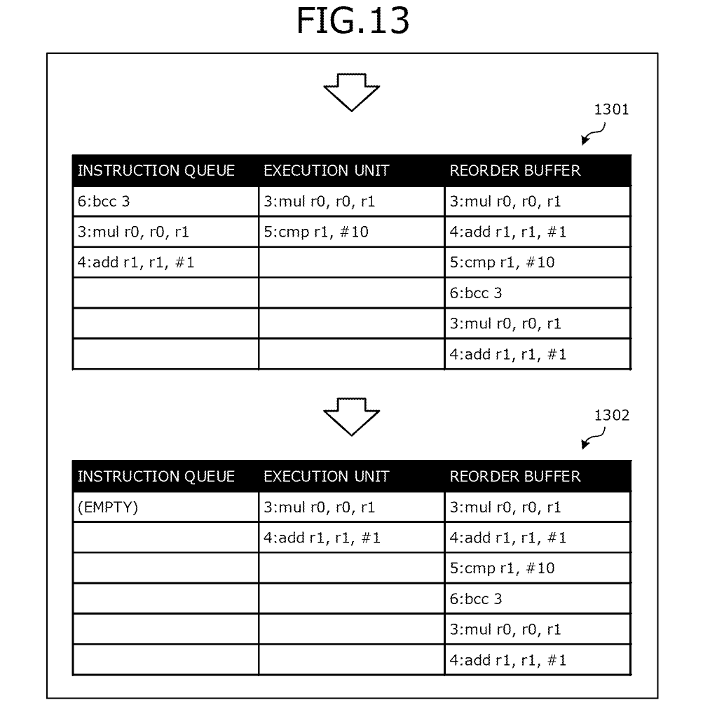

Next, in the operation simulation, the prediction simulation executing unit 312 executes stage_w( ). An internal state 1301 represents the internal state of the target CPU 600 after the execution of stage_w( ) (refer to FIG. 13).

In the internal state 1301, instruction 6, instruction 3, and instruction 4 are stored in the instruction queue 602; and instruction 3 and instruction 5 are input to execution units. Further, instruction 3, instruction 4, instruction 5, instruction 6, instruction 3, and instruction 4 are stored in the reorder buffer 607.

Here, although instruction 4 has been completed, instruction 3 is under execution and therefore, the internal state of the target CPU 600 before and after the execution of stage_w( ) does not change.

Next, in the operation simulation, the prediction simulation executing unit 312 executes stage_e( ). As a result, the main routine loop has been executed one time. An internal state 1302 represents the internal state of the target CPU 600 after execution of stage_e( ) (refer to FIG. 13).

In the internal state 1302, the instruction queue 602 is empty; and instruction 3 and instruction 4 are input to execution units. Further, instruction 3, instruction 4, instruction 5, instruction 6, instruction 3, and instruction 4 are stored in the reorder buffer 607.

Here, since execution of instructions 3 and 5 by the execution units has been completed, instructions 3 and 5 are deleted from the execution units. Further, since the execution units are available, instructions 3 and 4 from the instruction queue 602 are input to the execution units. Since instruction 6 is a branch instruction and the execution cycle count is “0”, instruction 6 is set as completed without being input to an execution unit.

The values of each variable (cycle, end) after one execution of the main routine loop are as follows.

cycle: 1

end: false

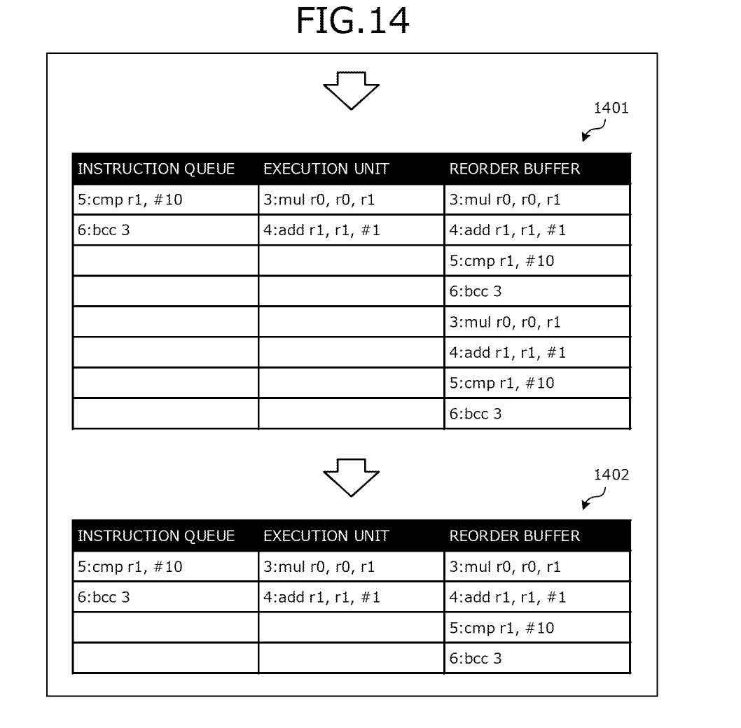

Next, in the operation simulation, the prediction simulation executing unit 312 executes stage_d( ) a second time. An internal state 1401 represents the internal state of the target CPU 600 after execution of stage_d( ) the second time (refer to FIG. 14).

In the internal state 1401, instruction 5 and instruction 6 are stored in the instruction queue 602; and instruction 3 and instruction 4 are input to execution units. Further, instruction 3, instruction 4, instruction 5, instruction 6, instruction 3, instruction 4, instruction 5, and instruction 6 are stored in the reorder buffer 607.

Here, since instruction 6 is the last instruction of the process block 701, the value of the variable (end) becomes “true”.

Next, in the operation simulation, the prediction simulation executing unit 312 executes stage_w( ) a second time. An internal state 1402 represents the internal state of the target CPU 600 after execution of stage_w( ) the second time (refer to FIG. 14).

In the internal state 1402, instruction 5 and instruction 6 are stored in the instruction queue 602; and instruction 3 and instruction 4 are input to execution units. Further, instruction 3, instruction 4, instruction 5, and instruction 6 are stored in the reorder buffer 607.

Here, since instructions 3, 4, 5, and 6 have been completed, instructions 3, 4, 5, and 6 are deleted from the reorder buffer 607.

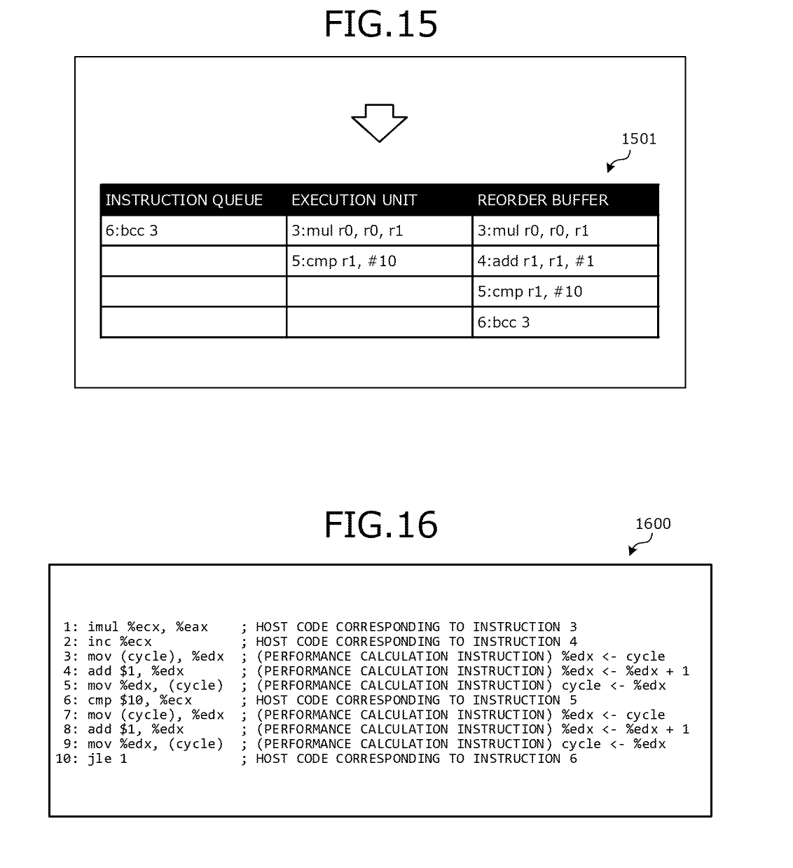

Next, in the operation simulation, the prediction simulation executing unit 312 executes stage_e( ) a second time. As a result, the main routine loop has been executed two times. An internal state 1501 represents the internal state of the target CPU 600 after execution of stage_e( ) the second time (refer to FIG. 15).

In the internal state 1501, instruction 6 is stored in the instruction queue 602; and instruction 3 and instruction 5 are input to execution units. Further, instruction 3, instruction 4, instruction 5, and instruction 6 are stored in the reorder buffer 607.

Here, since execution of instruction 4 by an execution unit has been completed, instruction 4 is deleted from the execution unit. Since instruction 3 takes two cycles by the MUL instruction, the execution of instruction 3 has not finished. Further, since an ALU execution unit is available, instruction 5 from the instruction queue 602 is input to the execution unit. Further since instruction 6 is dependent on instruction 5 and cannot be executed, instruction 6 remains in the instruction queue 602, without being executed.

The values of each variable (cycle, end) after two executions of the main routine loop are as follows.

cycle: 2

end: true

Here, since the value of the variable (end) is “true”, the prediction simulation executing unit 312 returns simulation results indicating the execution period and the execution start time of executed instructions of the process block 701 the second time. As a result, in the operation simulation, execution of the process block 701 ends.

A detailed example of the host code hc in a case where no externally dependent instruction is included in the process block will be described. For example, the execution period and the execution start time of each instruction of the process block 701 output as simulation results of the process block 701 in the operation simulation described above, for example, are as follows.

<Execution Start Time of Each Instruction>

instruction 3: 0

instruction 4: 0

instruction 5: 1

instruction 6: 2

<Execution Period of Each Instruction>

instruction 3: 0

instruction 4: 1

instruction 5: 1

The code generating unit 313 compiles the target code of the process block 701 and thereby, generates host code hc (at this time point, only function code fc) executable by the host CPU. The code generating unit 313, based on simulation results of the process block 701 in the operation simulation, further generates timing code tc for the process block 701 and embeds the timing code tc into the host code hc.

More specifically, for example, the code generating unit 313 generates timing code tc that sets the performance value immediately after instruction 4 to “+1” and sets the performance value immediately after instruction 5 to “+1”. The performance value is the execution period during which the process block 701 is executed by the target CPU. Here, host code hc based on the simulation results for the process block 701 described above will be described.

FIG. 16 is a diagram depicting a detailed example of the host code hc. In FIG. 16, host code 1600 is code (x86 instruction) enabling the host CPU to calculate the execution period for a case where the target CPU executes the process block 701.

In the host code 1600, line 1 is host code (function code) corresponding to instruction 3; and line 2 is host code (function code) corresponding to instruction 4. Further, line 6 is host code (function code) corresponding to instruction 5; and line 10 is host code (function code) corresponding to instruction 6.

Lines 2 to 5 are performance calculation instructions (timing code) that set the performance value immediately after instruction 4 to “+1”, lines 7 to 9 are performance calculation instructions (timing code) that set the performance value immediately after instruction 5 to “+1”. The execution period for a case where the target CPU executes the process block 701 is 2 cycles.

Next, a detailed example of the host code hc for a case where an externally dependent instruction is included in the process block will be described. First, target code of a target program TP that includes an externally dependent instruction will be described.

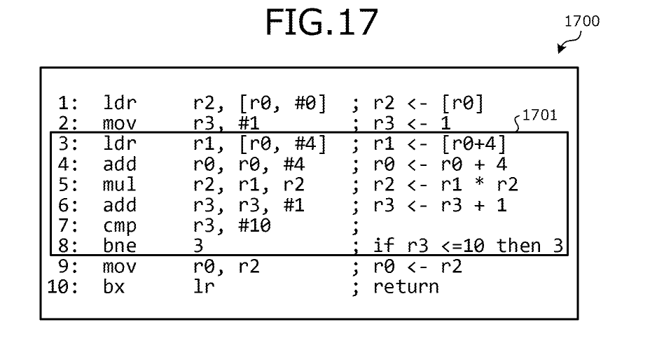

FIG. 17 is a diagram depicting an example of the target code. In FIG. 17, target code 1700 is a subroutine that obtains a value obtained by multiplying all 10 data of addresses indicated by register r0. When described in C language, the target code 1700, for example, is as follows.

```
int func(int a[ ])
{
  int i;
  int r=a[0];
  for (i=; i<10; i++)
    r *=a[i];
  return r;
}
```

Instructions 1 and 3, which are LDR instructions, load from memory and are externally dependent instructions. Further, instructions 8 and 10 are branch instructions. Here, LDR instructions are assumed to take two clock cycles in the case of cache hit. Further, instruction 5 uses the result of instruction 3 and therefore, is executed after the completion of instruction 3. Instruction 6 is not dependent on instructions 3, 4, or 5 and therefore, is executed before instruction 5. Instruction 7 uses the result of instruction 6 and therefore, is executed after the completion of instruction 6. Instruction 8 uses the result of instruction 7 and therefore, is executed after the completion of instruction 7.

In this case, the execution start time of each instruction of a process block 1701 configured by instructions 3 to 8 is as follows based on dependency relations among the instructions.

<Execution Start Time of Each Instruction>

instruction 3: 0

instruction 4: 0

instruction 5: 2

instruction 6: 1

instruction 7: 2

instruction 8: 3

Further, the execution period of each instruction of the process block 1701 is as follows. However, instruction 3 is an externally dependent instruction and therefore, the execution period of instruction 3 is calculated by a helper function. Here, the helper function call instruction is assumed to be

“cache_ld(address,rep_delay,pre_delay)”.

<Execution Period of Each Instruction>

instruction 3: calculation by helper function:

rep_delay=1,pre_delay=−1

instruction 4: 0

instruction 5: 0

instruction 6: 0

instruction 7: 1

The code generating unit 313 compiles the target code of the process block 1701 and thereby, generates the host code hc executable by the host CPU (at this time point, only function code fc). The code generating unit 313, based on simulation results of the process block 1701 in the operation simulation, generates the timing code tc for the process block 1701 and embeds the timing code tc into the host code hc.

More specifically, for example, the code generating unit 313 calls a helper function immediately after instruction 3, and generates timing code tc that sets the performance value immediately after instruction 7 to “+1”. Here, host code hc based on the simulation results of the process block 1701 will be described.

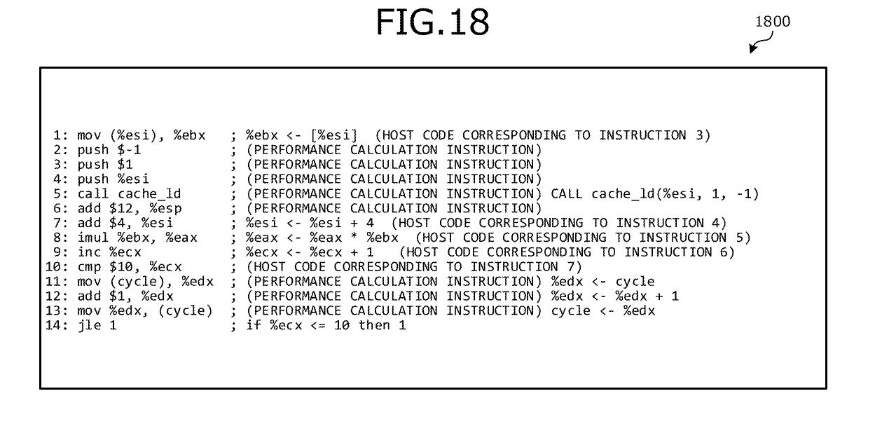

FIG. 18 is a diagram depicting an example of the host code hc. In FIG. 18, host code 1800 is code (x86 instruction) enabling the host CPU to calculate the execution period for a case where the target CPU executes the process block 1701.

In the host code 1800, line 1 is host code (function code) corresponding to instruction 3, and line 7 is host code (function code) corresponding to instruction 4. Further, line 8 is host code (function code) corresponding to instruction 5; line 9 is host code (function code) corresponding to instruction 6; and line 10 is host code (function code) corresponding to instruction 7.

Lines 2 to 6 are performance calculation instructions (timing code) to calculate the execution period of instruction 3 by a helper function immediately after instruction 3; and lines 11 to 13 are performance calculation instructions (timing code) to set the performance value to “+1” immediately after instruction 7. Here, calling of helper function cache_ld(% esi,1,−1) is realized by instructions 3 to 6.

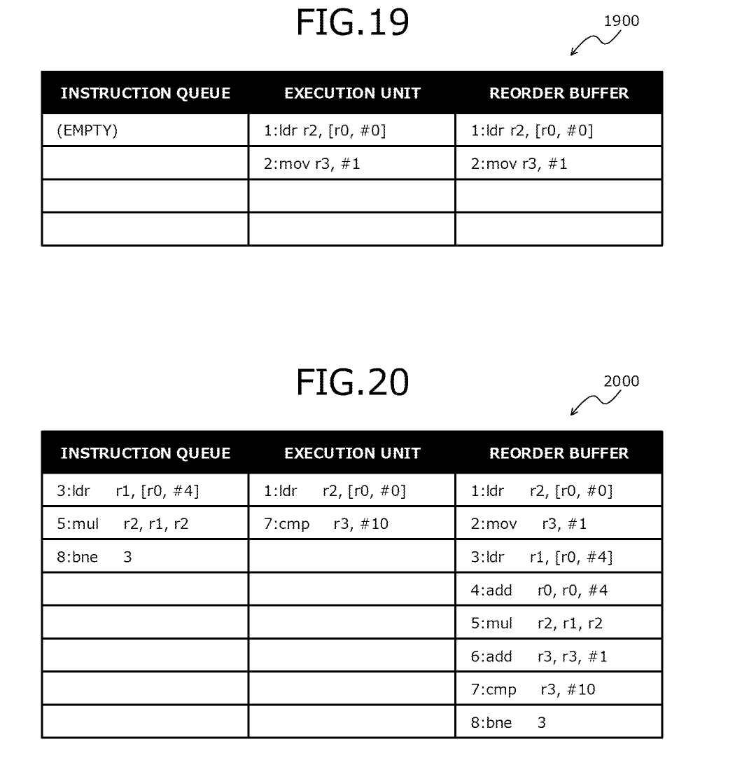

An example of a change in the internal state of the target CPU when in the operation simulation, operation is simulated for a case where the target CPU 600 executes the target code 1700 will be described with reference to FIGS. 19 to 22.

FIGS. 19, 20, 21, and 22 are diagrams depicting an example of changes in the internal state of the target CPU. However, here, portions of the internal state of the target CPU during operation simulation for a case where the target CPU 600 executes the target code 1700 will be selectively described.

In FIG. 19, an internal state 1900 represents the internal state of the target CPU 600 at the start of execution of the process block 1701 in operation simulation. Here, as the internal state of the target CPU 600, instructions stored in the instruction queue 602, instructions input to execution units (the ALUs 603, 604, the load/store unit 605, the branching unit 606), and instructions stored in the reorder buffer 607 are depicted.

In the internal state 1900, the instruction queue 602 is empty; and instruction 1(ldr r2,[r0,#0]) and instruction 2(mov r3,#1) are input to execution units. Further, instruction 1(ldr r2,[r0,#0]) and instruction 2(mov r3,#1) are stored in the reorder buffer 607.

In operation simulation, similar to the case described with reference to FIGS. 8 to 15, the prediction simulation executing unit 312 repeatedly executes a loop of the main routine until the value of the variable (end) of the main routine become “true”.

In FIG. 20, an internal state 2000 represents the internal state of the target CPU 600 at the completion of execution of the process block 1701 in operation simulation.

In the internal state 2000, instruction 3(ldr r1,[r0,#4]), instruction 5(mul r2,r1,r2), and instruction 8(bne 3) are stored in the instruction queue 602; and instruction 1(ldr r2,[r0,#0]) and instruction 7(cmp r3,#10) are input to execution units.

Further, instruction 1(ldr r2,[r0,#0]), instruction 2(mov r3,#1), instruction 3(ldr r1,[r0,#4]), instruction 4(add r0,r0,#4), instruction 5(mul r2,r1,r2), instruction 6(add r3,r3,#1), instruction 7(cmp r3,#10), and instruction 8(bne 3) are stored in the reorder buffer 607.

Here, since instruction 8, which is the last instruction of the process block 1701, is stored in the instruction queue 602, processing transitions to a new process block in the operation simulation. Here, by a condition branch instruction on line 8 of the target code 1700, processing returns to line 3, which is a branch destination, and the block B including lines 3 to 8 again becomes the process block until the value of r3 becomes greater than 10.

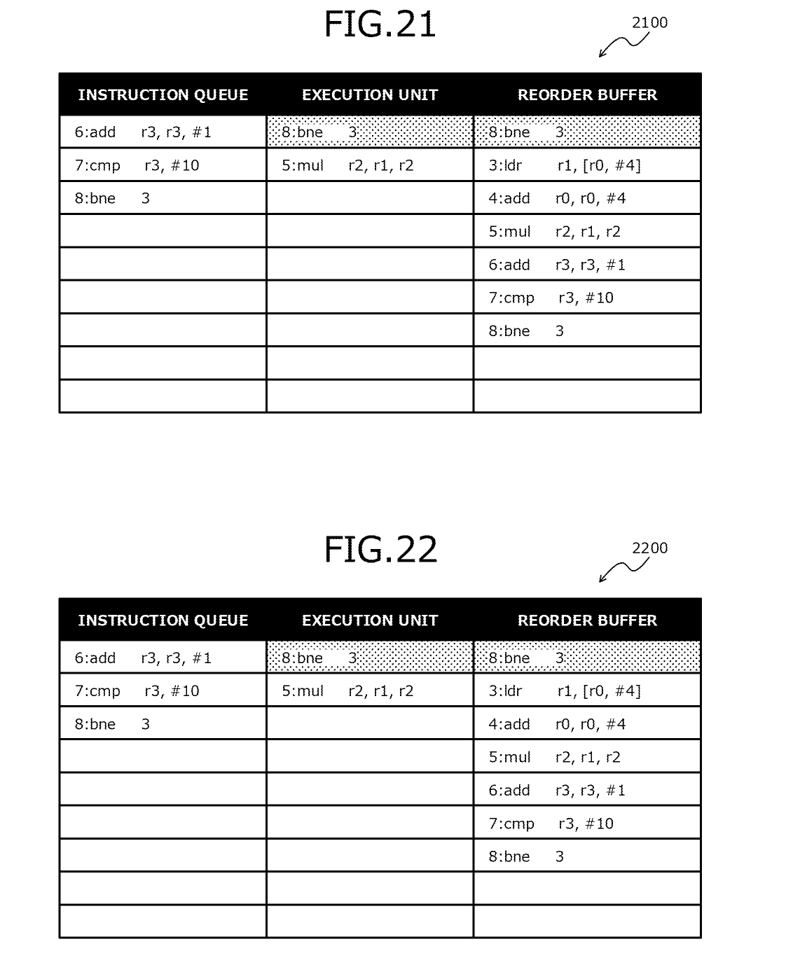

In FIG. 21, an internal state 2100 represents the internal state of the target CPU 600 at the completion of execution of the process block 1701 a sixth time in the operation simulation.

In the internal state 2100, instruction 6(add r3,r3,#1), instruction 7(cmp r3,#10), and instruction 8(bne 3) are stored in the instruction queue 602; and instruction 8(bne 3) and instruction 5(mul r2,r1,r2) are input to execution units. However, instruction 8(bne 3) is an instruction of the block B executed immediately before (the process block 1701 the fifth time).

Further, instruction 8(bne 3), instruction 3(ldr r1,[r0,#4]), instruction 4(add r0,r0,#4), instruction 5(mul r2,r1,r2), instruction 6(add r3,r3,#1), instruction 7(cmp r3,#10), and instruction 8(bne 3) are stored in the reorder buffer 607. However, the first instruction 8(bne 3) is an instruction of the block B executed immediately before (the process block 1701 the fifth time).

In FIG. 22, an internal state 2200 represents the internal state of the target CPU 600 at the completion of execution of the process block 1701 a seventh time in the operation simulation.

In the internal state 2200, instruction 6(add r3,r3,#1), instruction 7(cmp r3,#10), and instruction 8(bne 3) are stored in the instruction queue 602; and instruction 8(bne 3) and instruction 5(mul r2,r1,r2) are input to execution units. However, instruction 8(bne 3) is an instruction of the block B executed immediately before (the process block 1701 the sixth time).

Further, instruction 8(bne 3), instruction 3(ldr r1,[r0,#4]), instruction 4(add r0,r0,#4), instruction 5(mul r2,r1,r2), instruction 6(add r3,r3,#1), instruction 7(cmp r3,#10), and instruction 8(bne 3) are stored in the reorder buffer 607. However, the first instruction, instruction 8(bne 3), is an instruction of the block B executed immediately before (the process block 1701 the sixth time).

Here, in comparing the internal state 2100 of the target CPU 600 at the completion of execution of the process block 1701 the sixth time, depicted in FIG. 21, and the internal state of 2200 the target CPU 600 at the completion of execution of the process block 1701 the seventh time, depicted in FIG. 22, the internal states of the target CPU are identical.

In this case, the internal state of the target CPU 600 at the start of execution of the process block 1701 the seventh time, and the internal state of the target CPU 600 at the start of execution of the process block 1701 an eighth time are identical. In other words, the host code hc generated for the process block 1701 the seventh time can be reused for the process block 1701 the eighth time. Therefore, the code generating unit 313 does not generate host code hc for the process block 1701 the eighth time.

More specifically, for the process block 1701 the eighth time, the code translating unit 310 not only refrains from generating the function code fc, but also does not perform operation simulation or generate the timing code tc. As a result, repeated generation of the same host code hc for the process block 1701 can be prevented and increases in the amount of memory used for the performance simulation of the target CPU can be suppressed. Further, processing that repeatedly generates the same host code hc can be curtailed, enabling faster performance simulation to be facilitated.

Performance simulation of estimating the execution period for a case where the target CPU executes the target program TP will be described.

(1) The code executing unit 321 of the simulation executing unit 320 uses the host code hc generated by the code translating unit 310, and performs performance simulation for the target program TP. The code executing unit 321 simulates execution of the instructions of the target program TP and obtains an execution period for each instruction.

(2) The code executing unit 321, when detecting an externally dependent instruction (e.g., LD instruction) during simulation, determines whether the execution result differs from the set predicted result and if the execution result differs, requests startup of the correcting unit 322. For example, when a load instruction ld is detected, if the predicted result (cache hit) for the data cache and the actual execution result (cache miss) differ, the correcting unit 322 is called.

(3) The correcting unit 322 starts up upon being called and corrects the execution period (cycle count) of the detected instruction. The correcting unit 322 further changes the execution timing t+n of the next instruction by this correction. Each time the execution result of an externally dependent instruction differs from the predicted result, the correcting unit 322 corrects the execution period of the instruction.

Here, the execution period of an externally dependent instruction in a predicted case is already set as a constant. Therefore, the correcting unit 322 can calculate the execution period of an externally dependent instruction for a case other than the predicted case, by simply adding or subtracting a value of the penalty period for the instruction, the execution periods of the instructions executed before and after, the delay period of an instruction processed before, etc.

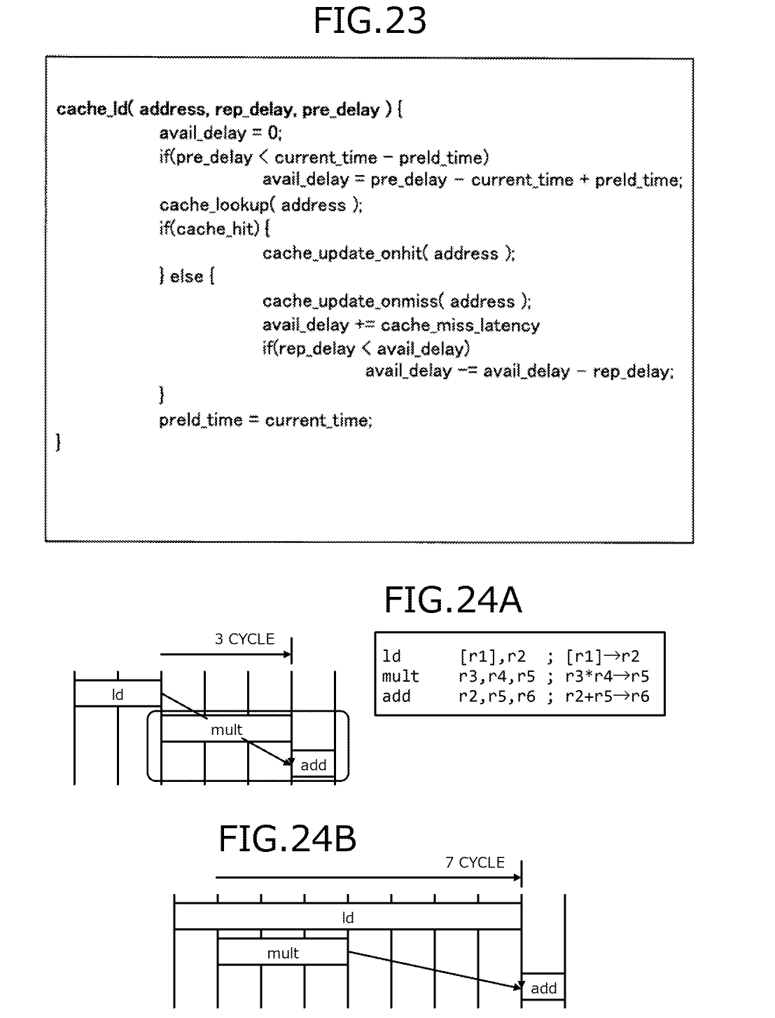

FIG. 23 is a diagram depicting processing operation of the correcting unit 322. The correcting unit 322 is implemented as a helper function module. In the present embodiment, for example, the correcting unit 322 is realized by embedding a helper function call instruction “cache_ld(address,rep_delay,pre_delay)” into the host code, in place of a function “cache_ld(address)” performing simulation, for each execution result of an LD instruction related to cache.

“rep_delay” of the helper function is an interval (deferment period) of the penalty period, not processed as delay and lasting until execution of the next instruction, which uses a return value of this load (ld) instruction. “pre_delay” is a delay period incurred from the instruction immediately before. “−1” indicates that there is no delay with respect to the previous instruction. “rep_delay” and “pre_delay” are time information obtained from the results of static analysis of the performance simulation results and the timing information 340.

In the operation example depicted in FIG. 23, when the difference of a current timing current_time and an execution timing preld_time of the LD instruction immediately before exceeds pre_delay, which is equivalent to the delay period of the LD instruction immediately before, the correcting unit 322 adjusts the delay period pre_delay by the execution timing preld_time of the LD instruction immediately before and a period until the current timing current_time, to obtain an effective delay period avail_delay.

Next, if the execution result is a cache miss, the predicted result is errant and the correcting unit 322 adds a penalty period cache_miss_latency at the time of the cache miss to the effective delay period avail_delay and based on the deferment period rep_delay, corrects the execution period of the LD instruction.

An example of correcting LD instruction execution results by the correcting unit 322 will be described with reference to FIGS. 24A to 26C.

FIGS. 24A, 24B, and 24C are diagrams of an example of correcting LD instruction execution results. FIGS. 24A, 24B, and 24C depict an example of correction when in a case where one cache process is executed and one cache miss occurs.

In the example depicted in FIGS. 24A, 24B, and 24C, the following three instructions are simulated.

“ld [r1],r2:[r1]→r2;

mult r3,r4,r5:r3*r4→r5;

add r2,r5,r6:r2+r5→r6”

FIG. 24A depicts an example of a timing chart in a case where the predicted result is “cache hit”. In the predicted case, at an ADD instruction executed third, a 2-cycle stall occurs. FIG. 24B depicts an example of a timing chart in a case of “cache miss” different from the predicted result. In this mispredicted case, when the execution result of the LD instruction is a cache miss, delay equivalent to the penalty cycle (6 cycles) occurs. As a result, a MULT instruction is executed without being affected by the delay, however, execution of the ADD instruction is held until completion of the LD instruction and therefore, a 4-cycle delay occurs. FIG. 24C depicts an example of a timing chart of instruction execution after correction by the correcting unit 322.

The correcting unit 322 adds a predetermined penalty period (6 cycles) for a cache miss to the remaining execution period (2−1=1 cycle) to set the effective delay period (7 cycles) since the execution result of the LD instruction is a cache miss (not the predicted result). The effective delay period is the maximum delay period. The correcting unit 322 further obtains the execution period (3 cycles) of the next instruction (MULT instruction), determines that the execution period of the instruction does not exceed the delay period, and sets the period (7−3=4 cycles), which is the difference of the effective delay period less the execution period of the next instruction, to be an execution period (delay period) during which delay of LD instruction occurs. Further, the correcting unit 322 sets the period (3 cycles), which is the difference of the effective delay period less the delay period above, to be the deferment period. The deferment period is a period of delay not regarded as a penalty. The correcting unit 322, by helper function cache_ld(address,rep_delay,pre_delay), returns the deferment period rep_delay=3 and delay period pre_delay of the previous instruction=−1 (no delay).

Consequent to this correction, the execution period of the LD instruction becomes an execution period (1+4=5 cycles) that is a sum of the executed period and the delay period, and the execution periods of the subsequent MULT instruction and ADD instruction from execution completion at timing t₁ are further added. In other words, the respective execution periods (3 cycles, 3 cycles) of the MULT instruction and the ADD instruction obtained using process results (result of prediction simulation using the predicted result) of the prediction simulation executing unit 312 are simply added to the corrected execution period (5 cycles) of the LD instruction whereby, the execution period (cycle count) of the block can be obtained.

Thus, a correction process of merely adding or subtracting the execution period of an instruction for which the execution result differs from the predicted result is performed, and for other instructions, by merely adding the execution period obtained when simulation is performed based on the predicted result, an execution cycle count in a case of simulation of cache miss can be obtained with high accuracy.

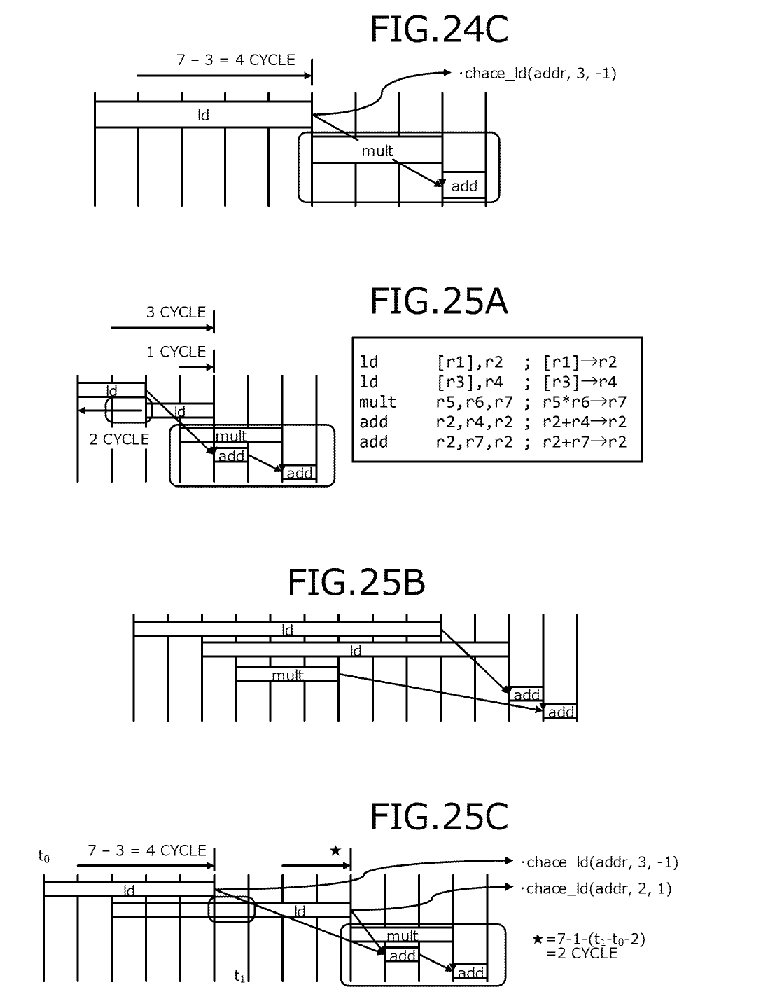

FIGS. 25A, 25B, and 25C are diagrams of an example of correcting LD instruction execution results. FIGS. 25A, 25B, and 25C depict an example of correction when in a case where two cache processes are executed, two cache misses occur. In the example depicted in FIGS. 25A, 25B, and 25C, the following five instructions are simulated.

“ld [r1],r2:[r1]→r2;

ld [r3],r4:[r3]→r4;

mult r5,r6,r7:r5*r6→r7;

add r2,r4,r2:r2+r4→r2;

add r2,r7,r2:r2+r7→r2”

FIG. 25A depicts an example of a timing chart in a case where the predicted result of the two cache processes is “cache hit”. In the predicted case, two LD instructions are assumed to be executed for 2 cycles (1 regular cycle+1 additional cycle). FIG. 25B depicts an example of a timing chart in a case of “cache miss” different from the predicted result for both of the cache processes. In this mispredicted case, the two LD instructions respectively result in a cache miss and a delay equivalent to the penalty cycle (6 cycles) occurs. However, the delay periods of the two LD instructions have a period of overlap; the MULT instruction is executed without being affected by the delay; and execution of the ADD instructions is delayed until completion of the second LD instruction. FIG. 25C depicts an example of a timing chart of instruction execution after correction by the correcting unit 322.

The correcting unit 322, as described with reference to FIGS. 24A, 24B and 24C, at timing t₀, corrects the delay period of the first LD instruction and returns helper function cache_ld(addr,3,−1). Next, at current timing t₁, since the execution result of the second LD instruction is a cache miss (not the predicted result), the correcting unit 322 adds penalty cycles (6) to the remaining execution period of the LD instruction, to set the effective delay period (1+6=7 cycles).

The correcting unit 322 subtracts from the effective delay period, the delay period (<current timing t₁−execution timing t₀ of previous instruction>−set interval) consumed until current timing t₁, obtains the extent by which the effective delay period (7−(6−2)=3 cycles) exceeds current timing t₁, and sets the extent by the effective delay period exceeds current timing t₁ as the execution period of the second LD instruction. The correcting unit 322 further subtracts the actual execution period from the extent by which the effective delay period exceeds current timing t₁ (3−1=2 cycles) and sets the difference as the delay period of the previous instruction. Further, the correcting unit 322 subtracts from the effective delay period, a sum of the delay period consumed until current timing t₁ and the extent to which the effective delay period exceeds current timing t₁ (7−(3+3)=1 cycles), and sets the difference as the deferment period.

The correcting unit 322, at timing t₁, after correcting the delay period of the second LD instruction, returns helper function cache_ld(addr,2,1). Consequent to this correction, a timing obtained by adding a correction value (3 cycles) to current timing t₁ becomes the timing when execution of the LD instruction is completed, and the execution periods of the subsequent MULT instruction and ADD instruction from this timing are added.

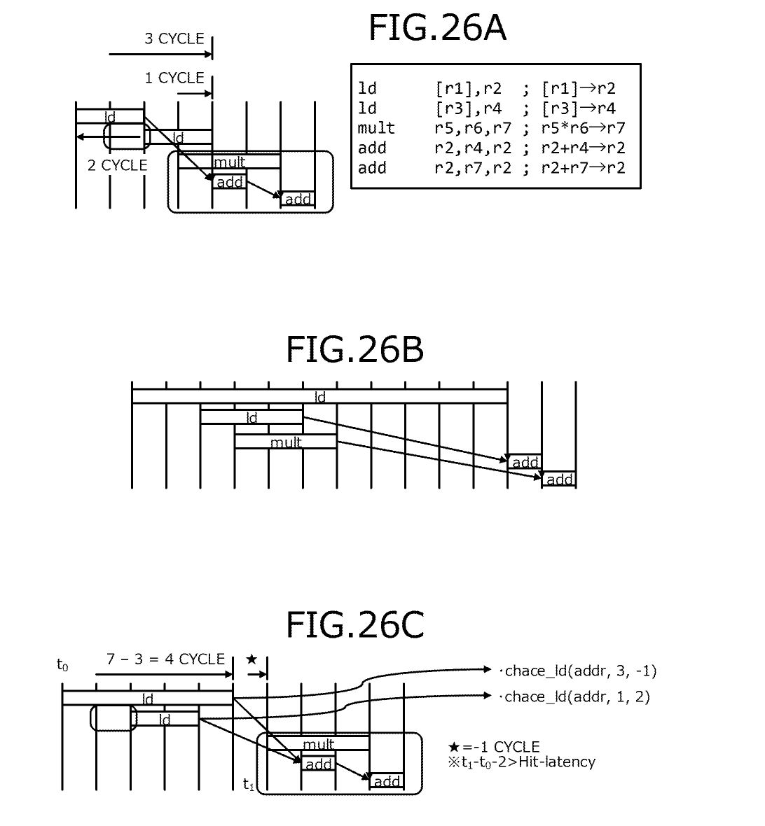

FIGS. 26A, 26B, and 26C are diagrams of an example of correcting LD instruction execution results. An example of correction when in a case where two cache processes are executed, one cache miss occurs will be described. In the example depicted in FIG. 26, simulation of the same five instructions of the example depicted in FIG. 25 is executed.

FIG. 26A depicts an example of a timing chart in a case where the predicted results of the two cache processes is “cache hit”. In this predicted case, similar to the case depicted in FIG. 25A, the two LD instructions are assumed to be executed 2 cycles (1 regular cycle+1 additional cycle). FIG. 26B depicts an example of a timing chart in a case where the result of the first LD instruction is a “cache miss”, which is different from the predicted result and the result of the second LD instruction is the predicted result (cache hit). In this mispredicted case, a delay of penalty cycles (6 cycles) occurs with respect to each of the two LD instructions. However, the delay periods of the two LD instructions have an overlapping period; the MULT instruction is executed without being affected by the delay; and the execution of the two ADD instructions becomes delayed until completion of the two LD instructions. FIG. 26C depicts an example of a timing chart of instruction execution after correction by the correcting unit 322.

The correcting unit 322, as described with reference to FIG. 24, at timing t₀, corrects the delay period of the first LD instruction, and returns helper function cache_ld(addr,3,−1). Next, at current timing t₁, since the execution result of the second LD instruction is a cache hit (predicted result), the correcting unit 322 determines that a period from the start of execution of this LD instruction until current timing t₁<t₁−t₀−set interval (6−0−2=4 cycles)> is greater than the execution period (2 cycles) of this LD instruction. Since the period from the start of execution of the second LD instruction until current timing t₁ is greater than the execution period (2 cycles) of this LD instruction, the correcting unit 322 sets current timing t₁ as the execution timing of the next instruction (MULT instruction).

The correcting unit 322 regards a period from the completion of execution of the second LD instruction until current timing t₁ (2 cycles) as the delay period for the next instruction and sets delay period pre_delay=2 for the previous instruction. Further, the correcting unit 322 subtracts from the effective delay period of the first LD instruction, a sum of the delay period consumed until current timing t₁ and the extent by which the effective delay period exceeds current timing t₁ (7−(6+0)=1 cycles) and sets the difference as the deferment period rep_delay=1, and returns helper function cache_ld(addr,1,2).

Procedures of each process by the simulation apparatus 100 will be described. First, a process procedure by the code translating unit 310 of the simulation apparatus 100 will be described.

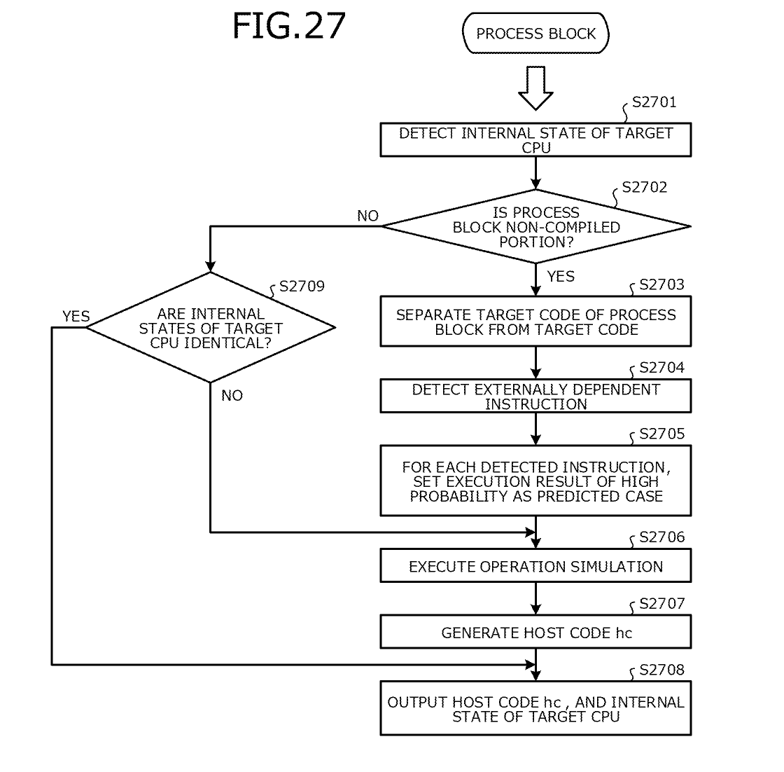

FIG. 27 is a flowchart of an example of the process procedure by the code translating unit 310. In the flowchart depicted in FIG. 27, after transition to a new process block in operation simulation, the code translating unit 310 references the host code list 400 and detects the internal state of the target CPU at the start of execution of the process block (step S2701).

Next, the code translating unit 310 references the host code list 400 and determines whether the process block is a non-compiled portion (step S2702). Here, if the process block is a non-compiled portion (step S2702: YES), the code translating unit 310 separates target code of the process block from target code of the target program TP (step S2703). The code translating unit 310 further associates the block ID of the process block and records into the host code list 400, the internal state of the target CPU at the start of execution of the process block.

The code translating unit 310 detects an externally dependent instruction included in the process block (step S2704). Next, for each of the detected instructions, the code translating unit 310 sets based on the prediction information 350, an execution result of high probability as a predicted case (step S2705).

The code translating unit 310 references the internal state of the target CPU and the timing information 340, and executes operation simulation that assumes the execution results (predicted cases) set as predicted results for the instructions of the process block (step S2706).

Next, the code translating unit 310 generates based on simulation results of the operation simulation, host code hc that enables calculation of the execution period of the process block (step S2707), and outputs the generated host code hc and the internal state of the target CPU at the completion of execution of the process block in the operation simulation (step S2708). As a result, host code hc and the internal state of the target CPU at the completion of execution of the process block are associated with the block ID of the process block and recorded into the host code list 400.

Further, at step S2702, if the process block has been compiled (step S2702: NO), the code translating unit 310 references the host code list 400, and determines whether the detected internal state of the target CPU is identical to the internal state of the target CPU, detected when the process block was previously subject to processing (step S2709).

Here, if the internal state of the target CPU is not identical (step S2709: NO), the code translating unit 310 transitions to step S2706. The code translating unit 310 associates the block ID of the process block, and records into the host code list 400, the internal state of the target CPU at the start of execution of the process block.

On the other hand, if the internal state of the target CPU is identical (step S2709: YES), the code translating unit 310 outputs the host code hc generated when the process block was previously subject to processing, and the internal state of the target CPU at the completion of execution of the process block in the operation simulation (step S2708).

As a result, the target code of the process block is compiled and host code hc can be output, the host code hc being the obtained function code fc into which timing code tc is embedded that estimates performance of the target CPU, taking the internal state of the target CPU into consideration. Further, repeated generation of the same host code hc for a given block B can be prevented. Further, when host code hc is generated consequent to the internal states of the target CPU being dissimilar (step S2709: NO), operations at steps S2703 to S2705 are not dependent on the internal state of the target CPU and can be omitted, enabling processing efficiency to be improved.

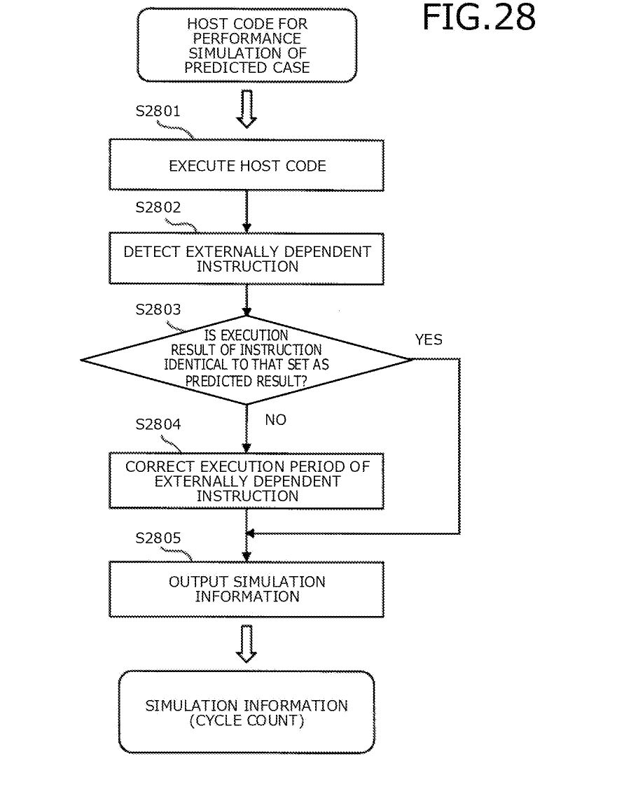

FIG. 28 is a flowchart of an example of the process procedure by the simulation executing unit 320. In FIG. 28, first, the simulation executing unit 320 references the host code list 400, executes the host code hc generated by the code translating unit 310, and executes performance simulation (step S2801). Next, the simulation executing unit 320 when detecting an externally dependent instruction during execution (step S2802), determines whether the execution result of the instruction is identical to that set as a predicted result (step S2803).

Here, if the execution result of the externally dependent instruction is not identical to the set predicted result (step S2803: NO), the simulation executing unit 320 corrects the execution period of the externally dependent instruction (step S2804). On the other hand, if the execution result of the externally dependent instruction is identical to the set predicted result (step S2803: YES), the simulation executing unit 320 transitions to step S2805 without performing the correction at step S2804.

The simulation information collecting unit 330 outputs the simulation information 360 of the process block (step S2805). Here, if performance simulation of the target CPU has not ended, the simulation information collecting unit 330 outputs information (e.g., block ID) of the next process block.

On the other hand, if performance simulation of the target CPU has been completed, configuration may be such that the simulation information collecting unit 330 outputs the simulation information 360, including an overall execution period for a case where the target CPU executes the target program TP. As a result, the simulation information 360 (cycle simulation information) of the target CPU executing target program TP can be output.

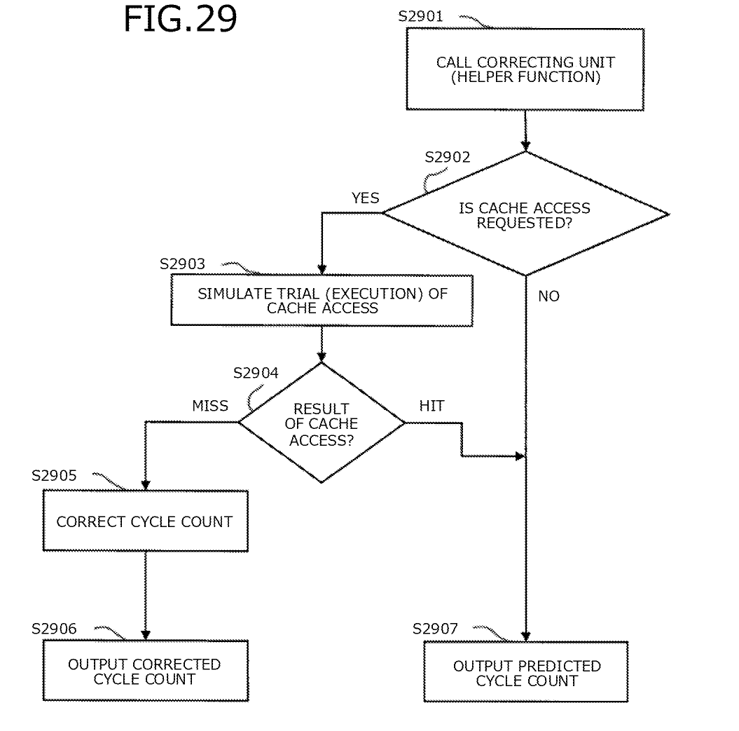

FIG. 29 is a flowchart of an example of the process procedure by the correcting unit 322. The process procedure of the correcting unit 322, which realizes the operations at steps S2802 to S2804 depicted in FIG. 28, will be described. Here, a load instruction will be taken as an example of an externally dependent instruction and a case will be described where determination and correction of the predicted result are performed in the processing of the load instruction.

In the flowchart depicted in FIG. 29, the code executing unit 321 of the simulation executing unit 320, when detecting an externally dependent instruction among the instructions of the process block, calls a helper function that corresponds to the correcting unit 322 (step S2901). Next, the code executing unit 321 determines whether cache access is requested by the LD instruction (step S2902).

Here, if cache access is requested (step S2902: YES), the code executing unit 321 simulates a trial (execution) of cache access (step S2903). If the result of the cache access is a “cache miss” (step S2904: “miss”), the correcting unit 322 corrects the execution period (cycle count) of the LD instruction (step S2905), and outputs the corrected execution period (cycle count) (step S2906).

Further, at step S2902, if cache access is not requested (step S2902: NO), the correcting unit 322 outputs the predicted execution period (cycle count) without correction (step S2907). Further, at step S2904, if the requested cache access results in a “cache hit” (step S2904: “hit”), the correcting unit 322 outputs the predicted execution period (cycle count) without correction (step S2907).

As a result, in the execution results for host code hc, when the execution result for an externally dependent instruction is different from the predicted result, the execution period of the externally dependent instruction can be corrected.

As described, according to the simulation apparatus 100 of the first embodiment, after transition to a new process block in operation simulation, the internal state of the target CPU at the start of execution of the process block can be detected. Further, according to the simulation apparatus 100, by executing operation simulation of the process block, based on the detected internal state of the target CPU, host code hc can be generated that enables the execution period to be calculated for a case where the target CPU executes the process block. According to the simulation apparatus 100, by executing the generated host code hc, the execution period for a case where the target CPU executes the process block can be calculated.

As a result, with consideration of the instruction execution sequence changing according to dependent relationships between instructions and the internal state of the target CPU, the execution period of the process block can be obtained and the accuracy of the performance estimation for the target CPU, which performs out-of-order execution, can be improved. For example, among instructions of a given block B, instructions not dependent on another instruction are sequentially executed and even when out-of-order execution of instructions occurs over blocks B, the execution period of each block B can be estimated with high accuracy.

Further, according to the simulation apparatus 100, after transition to a new process block, whether the process block is a block previously subject to processing can be determined. As a result, whether the process block is a non-compiled portion for which function code fc has not been generated can be determined.

According to the simulation apparatus 100, when the process block is a block previously subject to processing, whether the detected internal state of the target CPU is identical to the internal state of the target CPU detected when the process block was previously subject to processing can be determined. Further, according to the simulation apparatus 100, when the internal state of the target CPU is not identical, host code hc for the process block can be generated. Further, according to the simulation apparatus 100, configuration can be such that when the internal state of the target CPU is identical, host code hc for the process block is not generated. According to the simulation apparatus 100, when the internal state of the target CPU is identical, by executing the host code hc generated when the process block was previously subject to processing, the execution period of the process block can be calculated.

As a result, repeated generation of the same host code hc for a given block B can be prevented and increases in the amount of memory used for the performance simulation of the target CPU can be suppressed. Further, processing that repeatedly generates the same host code hc can be curtailed, enabling faster performance simulation to be facilitated.

According to the simulation apparatus 100, by setting as a predicted result, an execution result of an externally dependent instruction among the instructions included in the process block, operation simulation based on the detected internal state of the target CPU can be executed. As a result, increases in the code amount of the function code fc, resulting from inserting code for handling various patterns according to the execution result of the externally dependent instruction can be suppressed. As a result, increases in the load for performance simulation are suppressed while enabling performance simulation to be performed faster.

According to the simulation apparatus 100, in the execution results for host code hc, when the execution result for an externally dependent instruction is different from the predicted result, a preset correction value is used to correct the execution period of the externally dependent instruction, enabling the execution period of the process block to be calculated. As a result, the accuracy of the performance estimation of the target CPU can be enhanced.

The simulation apparatus 100 according to a second embodiment will be described. Portions identical to those described in the first embodiment will be given the same reference numerals used in the first embodiment and description thereof will be omitted hereinafter.

As described, the internal state of the target CPU includes various states of instruction queues, execution units, reorder buffer, etc. of the target CPU. However, when the number of various states contributing to the internal state of the target CPU is large, the internal state of the target CPU at the start of execution of the process block is often dissimilar to the internal state of the target CPU detected when the process block was previously subject to processing.

For example, even for a simple loop process of incrementing the value of a given register, the internal state of the target CPU for the n-th execution of the loop and for the (n+1)-th execution of the loop is often dissimilar. Further, when the internal state of the target CPU is frequently dissimilar, the number of times that host code hc can be reused decreases.

Here, taking an instruction queue of the target CPU as an example, an example of changes in the state of the instruction queue when a simple loop process is executed will be described.

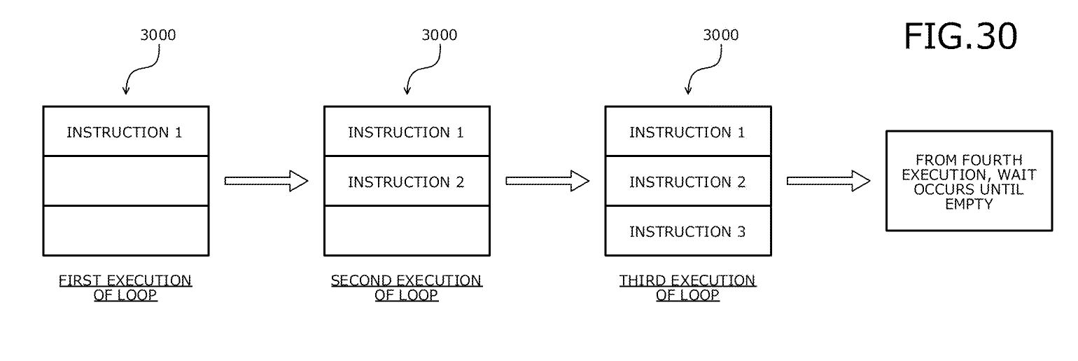

FIG. 30 is a diagram depicting an example of changes in the state of the instruction queue in the target CPU. Here, an upper limit of an instruction count of instructions that can be stored in an instruction queue 3000 of the target CPU is assumed to be “3” and for each loop, the instruction count of the instruction queue 3000 is assumed to increase by “1”. Further, for modules (e.g., execution units, reorder buffer, etc.) other than the instruction queue 3000, the upper limit is assumed to not be exceeded.

In this case, at the third execution of the loop, the instruction count of the instruction queue 3000 becomes “3”, at the fourth and subsequent executions of the loop, waiting occurs until the instruction queue 3000 becomes empty and the execution period (cycle count) of the instruction increases. On the other hand, at the first to third executions of the loop, there is no waiting for the instruction queue 3000 to become empty and therefore, the execution period (cycle count) of the instruction does not change.

Thus, even when the state of the instruction queue 3000 changes between the n-th execution of the loop and the (n+1)-th execution of the loop, until the upper limit of the instruction queue 3000 is exceeded, the execution period (cycle count) of the instruction does not change. In other words, even if the internal state of the target CPU is not identical, the execution period (cycle count) of the instruction may not change.

Thus, in the second embodiment, even when the internal state of the target CPU is not identical, provided that resource utilization such as the instruction queue used in executing the process block does not exceed the upper limit, the simulation apparatus 100 reuses generated host code hc of the process block. As a result, accuracy of the performance simulation can be secured and faster processing can be achieved.

An example of target code of the target program TP will be described.

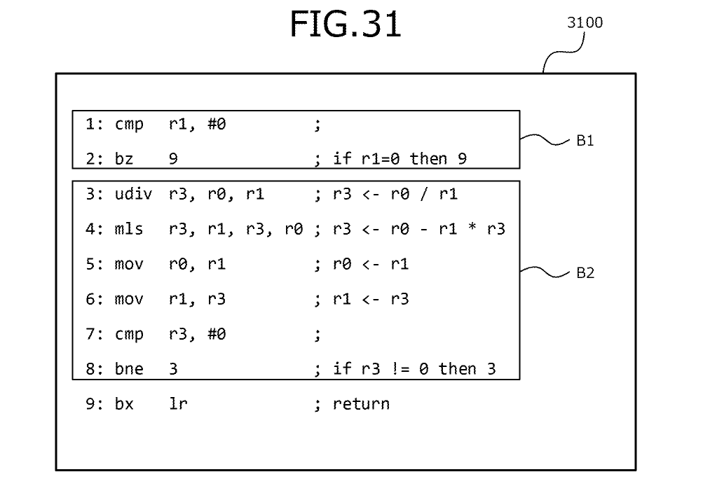

FIG. 31 is a diagram depicting an example of target code. In FIG. 31, target code 3100 is a program that obtains a greatest common factor, using a Euclidean algorithm. In the target code 3100, r0, r1 (r0≧r1) are input and the greatest common factor of r0, r1 is output.

When (i)r1=0, the target code 3100 outputs r0 and ends the process; when (ii)r1=0 does not result, the target code 3100 divides r0 by r1 and newly sets the remainder as r1, newly sets the original value of r1 as r0, returns to (i) above, and repeats the process. When described in C language, the target code 3100, for example, is as follows.

```
unsigned Euclid(unsigned a, unsigned b)
{
  unsigned r;
  if (b==0)
    return a;
  do{
    r=a%b;
    a=b;
    b=r;
  }while(r!=0);
  return a;
}
```

An example of changes in the internal state of the target CPU 600 in a case where in operation simulation, the target CPU 600 depicted in FIG. 6 executes the target code 3100 will be described.

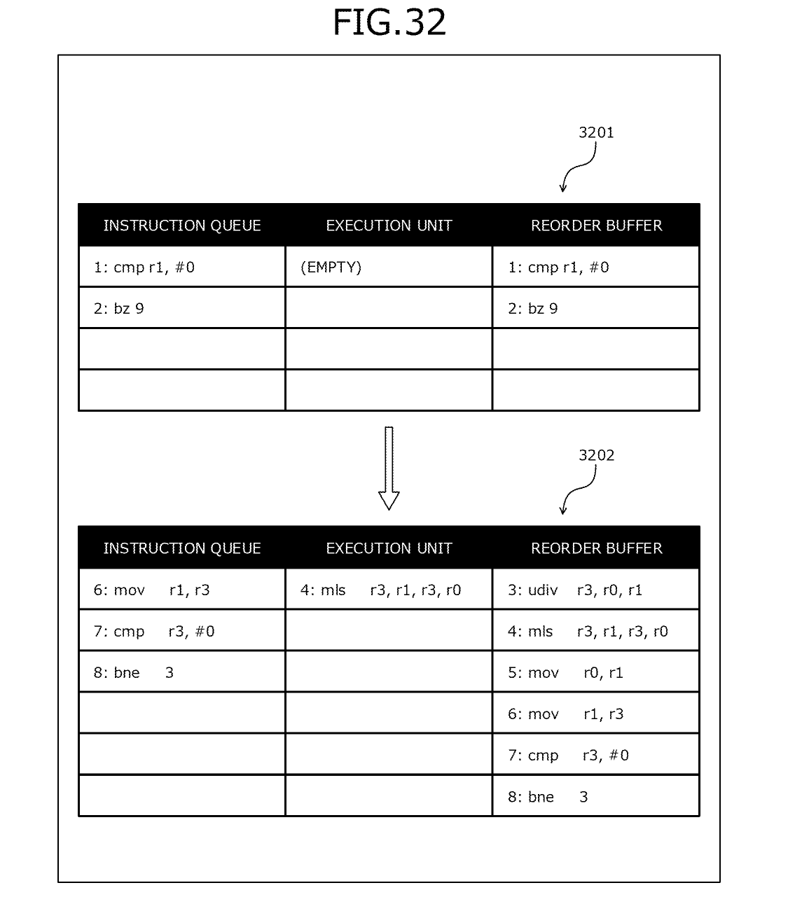

FIG. 32 is a diagram depicting an example of changes in the internal state of the target CPU. Here, lines 3 to 8 of the target code 3100 are assumed to be a block B2 (refer to FIG. 31) that is the process block; and lines 1 and 2 are assumed to be a block B1 (refer to FIG. 31) that is executed immediately before the process block. Further, the upper limit of the instruction count of instructions that can be stored to the instruction queue 602 of the target CPU 600 is assumed to be “4”.

In FIG. 32, an internal state 3201 represents the internal state of the target CPU 600 at the start of execution of the process block (block B2) in operation simulation. Here, as the internal state of the target CPU 600, instructions stored in the instruction queue 602, instructions input to execution units (the ALUs 603, 604, the load/store unit 605, the branching unit 606), and instructions stored in the reorder buffer 607 are depicted.

In the internal state 3201, instruction 1(cmp r1,#0) and instruction 2(bz 9) are stored in the instruction queue 602; and the execution units are available. Further, instruction 1(cmp r1,#0) and instruction 2(bz 9) are stored in the reorder buffer 607.

An internal state 3202 represents the internal state of the target CPU 600 at the completion of execution of the process block (block B2) in the operation simulation. In the internal state 3202, instruction 6(mov r1,r3), instruction 7(cmp r3,#0), and instruction 8(bne 3) are stored in the instruction queue 602.

Further, instruction 4(mls r3,r1,r3,r0) is input to an execution unit; and instruction 3(udiv r3,r0,r1), instruction 4(mls r3,r1,r3,r0), instruction 5(mov r0,r1), instruction 6(mov r1,r3), instruction 7(cmp r3,#0), and instruction 8(bne 3) are stored in the reorder buffer 607.

Thus, when the process block (block B2) is executed one time, the instruction count of the instruction queue 602 increases by “1”. Therefore, after completion of the second execution of the process block (block B2), the instruction queue 602 becomes full and the start of the third execution of the process block (block B2) is delayed.

The content stored in the host code list 400 used by the simulation apparatus 100 according to the second embodiment will be described.

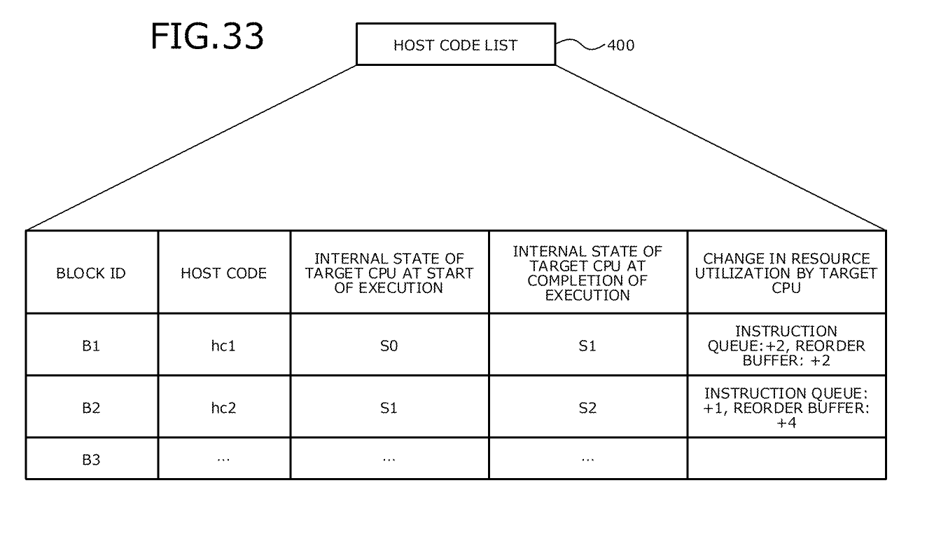

FIG. 33 is a diagram depicting an example of the contents stored by the host code list 400. In FIG. 33, the host code list 400 associates and stores a block ID, host code, the internal state of the target CPU at the start of execution, the internal state of the target CPU at the completion of execution, and a change in resource utilization by the target CPU.

Here, the block ID is an identifier of a block B obtained by dividing the target code. The host code is the host code hc of the block B. The internal state of the target CPU at the start of execution is the internal state of the target CPU at the start of execution of the block B in operation simulation.

The internal state of the target CPU at the completion of execution is the internal state of the target CPU at the completion of execution of the block B in the operation simulation. A change in resource utilization by the target CPU is a change in the amount of a resource used by the target CPU before and after execution of the block B. Resource utilization by the target CPU is the amount of a resource used by the target CPU in executing the block B in operation simulation.

A resource of the target CPU is a module that the target CPU has for realizing out-of-order execution, e.g., an instruction queue, execution unit, reorder buffer, etc. of the target CPU. Resource utilization by the target CPU, for example, is expressed by an instruction count of instructions stored in the reorder buffer or instruction queue, or an instruction count of instructions input to execution units of the target CPU.

Although not depicted, an increase/decrease of execution units (the ALUs 603, 604, the load/store unit 605, the branching unit 606) used in executing the block B in operation simulation is also stored in the host code list 400 as a change in resource utilization by the target CPU.

For example, the host code hc1 of the block B1, the internal state S0 of the target CPU at the start of execution of the block B1, and the internal state S1 of the target CPU at the completion of execution of the block B1 are associated with the block ID “B1” of the block B1 and stored in the host code list 400. Further, a change in resource utilization by the target CPU “instruction queue: +2, reorder buffer: +2” is associated with the block ID “B1” of the block B1 and stored in the host code list 400.

Functional units of the simulation apparatus 100 according to the second embodiment will be described. However, the functional configuration of the simulation apparatus 100 according to the second embodiment is the same as the functional configuration example of the simulation apparatus 100 depicted in FIG. 3 and therefore, description thereof will be omitted hereinafter. Further, among the functional units of the simulation apparatus 100 according to the second embodiment, those identical to the functional units described in the first embodiment are given the same reference numerals used in the first embodiment and description thereof is omitted hereinafter.

The prediction simulation executing unit 312, after transition to a new process block, determines whether the process block is a block previously subject to processing. More specifically, for example, the prediction simulation executing unit 312 references the host code list 400 depicted in FIG. 33 and determines whether the block ID of the process block is registered.

If the block ID of the process block is registered, the prediction simulation executing unit 312 determines that the process block is a block previously subject to processing. On the other hand, if the block ID of the process block is not registered, the prediction simulation executing unit 312 determines that the process block is not a block previously subject to processing.

Here, when determining that the process block is not a block previously subject to processing, the prediction simulation executing unit 312 executes based on the detected internal state of the target CPU at the start of execution of the process block, operation simulation of the process block. The code generating unit 313 generates host code hc of the process block, based on the simulation results obtained by the prediction simulation executing unit 312.

Further, the prediction simulation executing unit 312, when determining that the process block is a block previously subject to processing, determines whether the detected internal state of the target CPU at the start of execution of the process block is identical to the internal state of the target CPU at the start of execution of the process block, detected when the process block was previously subject to processing.

More specifically, for example, the prediction simulation executing unit 312 references the host code list 400 (refer to FIG. 33) and determines whether the detected internal state of the target CPU at the start of execution of the process block is identical to the internal state of the target CPU at the start of execution, associated with the block ID of the process block.

Here, if the internal state of the target CPU is identical, the prediction simulation executing unit 312 does not execute operation simulation of the process block. Further, the code generating unit 313 does not generate host code hc of the process block. In other words, if the internal state of the target CPU at the start of execution is identical, the host code hc generated when the process block was previously subject to processing can be reused and therefore, the code generating unit 313 does not generate host code hc for the process block.

On the other hand, if the internal state of the target CPU is not identical, the prediction simulation executing unit 312 determines whether resource utilization by the target CPU in executing the process block exceeds an upper limit. More specifically, for example, the prediction simulation executing unit 312, based on a change in resource utilization by the target CPU before and after execution of the process block, determines whether resource utilization by the target CPU exceeds the upper limit.

The resource upper limit of the target CPU, for example, is expressed by an instruction count of instructions stored in the reorder buffer or instruction queue, or the instruction count of instructions input to execution units of the target CPU. Further, information indicating the resource upper limit of the target CPU, for example, is stored in a storage apparatus such as the RAM 203, the disk 205, etc.

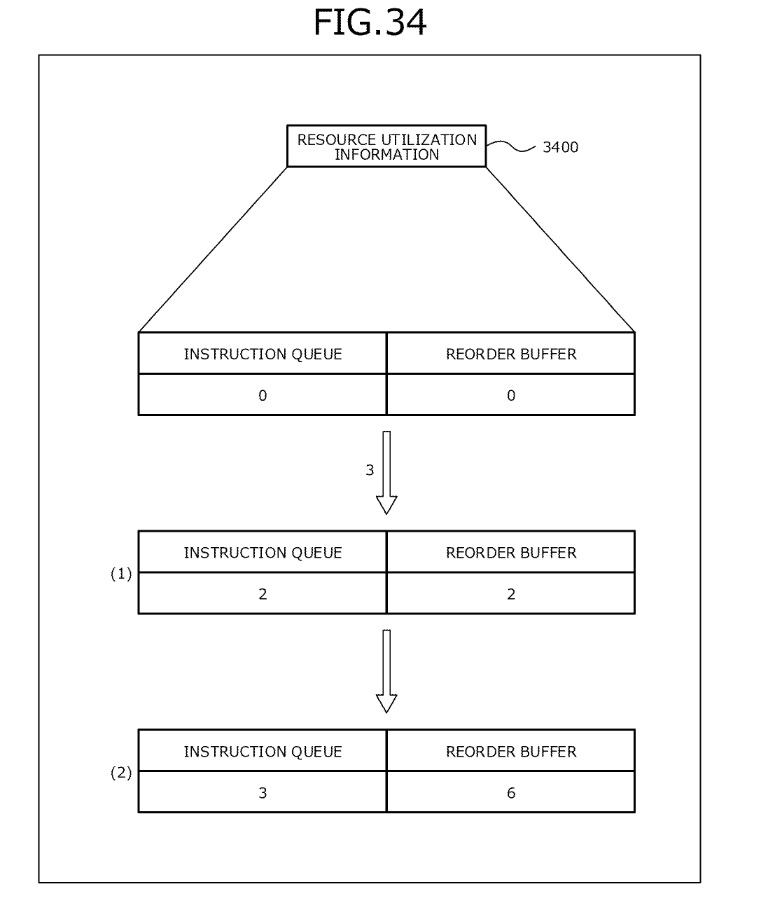

More specifically, the prediction simulation executing unit 312, for example, references resource utilization information 3400 such as that depicted in FIG. 34 described hereinafter, and determines whether resource utilization by the target CPU exceeds the upper limit. An example of the determination of whether resource utilization by the target CPU exceeds the upper limit will be described hereinafter with reference to FIG. 34.

Here, if resource utilization by the target CPU does not exceed the upper limit, the prediction simulation executing unit 312 does not execute operation simulation of the process block. Further, the code generating unit 313 does not generate host code hc for the process block.

In other words, if resource utilization by the target CPU does not exceed the upper limit, the execution period (cycle count) of the process block does not change and therefore, the host code hc generated when the process block was previously subject to processing can be reused. Consequently, the code generating unit 313 refrains from generating host code hc for the process block.

Further, when resource utilization by the target CPU does not exceed the upper limit, the code executing unit 321 executes the host code hc generated when the process block was previously subject to processing. In other words, if resource utilization by the target CPU does not exceed the upper limit, the code executing unit 321 executes the generated host code hc of the process block and thereby, calculates the execution period for a case where the target CPU executes the process block.

On the other hand, if resource utilization by the target CPU exceeds the upper limit, the prediction simulation executing unit 312 executes based on the detected internal state of the target CPU at the start of execution of the process block, operation simulation of the process block. The code generating unit 313 generates based on the simulation results obtained by the prediction simulation executing unit 312, host code hc for the process block.

In other words, if resource utilization by the target CPU exceeds the upper limit, the execution period (cycle count) of the process block in the operation simulation changes and therefore, the host code hc generated when the process block was previously subject to processing cannot be reused. Therefore, the code generating unit 313 generates host code hc for the process block.

Further, the code generating unit 313 generates based on the internal state of the target CPU at the start of execution of the process block and the internal state of the target CPU at the completion of execution of the process block, change information that indicates changes in resource utilization by the target CPU before and after execution of the process block.

Here, description will be given taking the internal state of the target CPU depicted in FIG. 32 as an example. The code generating unit 313 compares the internal state 3201 at the start of execution of the process block (block B2) and the internal state 3202 at the completion of execution of the process block (block B2).

In the example depicted in FIG. 32, after execution of the process block (block B2), the instruction count of the instruction queue 602 has increased by “1”, the instruction count for the execution units (the ALUs 603, 604, the load/store unit 605, the branching unit 606) has increased by “1”, and the instruction count of the reorder buffer 607 has increased by “4”.

In this case, the code generating unit 313 generates change information (instruction queue: +1, execution unit: +1, reorder buffer: +4) indicating changes in resource utilization by the target CPU before and after execution of the process block (block B2). The code generating unit 313 associates the block ID “B2” of the process block (block B2) and records into the host code list 400, the changes in resource utilization by the target CPU.

Further, if the code executing unit 321 has executed the host code hc of the process block, the code executing unit 321 calculates resource utilization by the target CPU. More specifically, for example, the code executing unit 321 references the host code list 400 (refer to FIG. 33) and identifies changes in resource utilization by the target CPU before and after execution of the process block and for which the host code hc was executed. The code executing unit 321 generates based on the identified changes in resource utilization by the target CPU, resource utilization information that indicates the changes in resource utilization by the target CPU.

Here, an example of generation of the resource utilization information that indicates changes in resource utilization by the target CPU in a case where the target code 3100 is executed will be described with reference to FIG. 34.

FIG. 34 is a diagram depicting an example of generation of the resource utilization information. In FIG. 34, the resource utilization information 3400 is information that indicates resource utilization by the target CPU 600. Here, description will be given taking the instruction queue 602 and the reorder buffer 607 as resources of the target CPU 600.

Further, resource utilization by the target CPU 600 is expressed by the instruction count of instructions stored in the instruction queue 602 and the instruction count of instructions stored in the reorder buffer 607. At the initial state, the instruction queue 602 and the reorder buffer 607 are assumed to be empty. In other words, in the initial state, the instruction counts of the instruction queue 602 and the reorder buffer 607 are respectively “0”.

First, if the code executing unit 321 has executed the host code hc1 of the block B1, the code executing unit 321 references the host code list 400 (refer to FIG. 33) and identifies changes in resource utilization by the target CPU 600 before and after execution of the block B1. The code executing unit 321 records into the resource utilization information 3400, the identified changes in resource utilization by the target CPU 600.

Here, changes in resource utilization by the target CPU 600 “instruction queue: +2, reorder buffer: +2” are identified and recorded into the resource utilization information 3400 (in FIG. 34, (1)).

Next, if the code executing unit 321 has executed the host code hc2 of the block B2, the code executing unit 321 references the host code list 400 (refer to FIG. 33) and identifies changes in resource utilization by the target CPU 600 before and after execution of the block B2. The code executing unit 321 further updates the resource utilization information 3400, based on the identified changes in resource utilization by the target CPU 600.

Here, changes in resource utilization by the target CPU 600 “instruction queue: +1, reorder buffer: +4” are identified and the resource utilization information 3400 is updated (in FIG. 34, (2)).

More specifically, the code executing unit 321 adds the identified instruction count of the instruction queue 602 “+1” to the instruction count of the instruction queue 602 “2”, in the resource utilization information 3400 and thereby, updates the instruction count of the instruction queue 602 to “3”. Further, the code executing unit 321 adds the identified instruction count of the reorder buffer 607 “+4” to the instruction count of the reorder buffer 607 “2” in the resource utilization information 3400 and thereby, updates the instruction count of the reorder buffer 607 to “6”.

Thus, each time the host code hc of the process block is executed, the resource utilization information 3400 indicating resource utilization by the target CPU 600 can be generated by updating resource utilization by the target CPU 600, based on change information concerning the process block.

Here, description of an example of determining whether resource utilization by the target CPU 600 exceeds an upper limit will be given taking the resource utilization information 3400 depicted at (2) in FIG. 34 as an example. Here, an example of determining whether resource utilization of the instruction queue 602 by the target CPU 600 exceeds an upper limit will be described assuming that the upper limit of the instruction queue 602 of the target CPU 600 is “3”.

Here, the change in resource utilization of the instruction queue 602 by the target CPU 600 before and after execution of the process block (block B2) is “+1” (refer to FIG. 33). Therefore, the prediction simulation executing unit 312 references the resource utilization information 3400, adds “+1” to resource utilization of the instruction queue 602 by the target CPU 600 “3”, and calculates resource utilization of the instruction queue 602 to be “4”.

As a result, resource utilization “4” of the instruction queue 602 by the target CPU 600 when the process block (block B2) is next executed can be obtained. The prediction simulation executing unit 312 determines whether the calculated resource utilization “4” of the instruction queue 602 exceeds the upper limit “3” for the instruction queue 602. In this example, the prediction simulation executing unit 312 determines that the upper limit “3” for the instruction queue 602 is exceeded.

Next, various process procedures of the simulation apparatus 100 according to the second embodiment will be described. First, the process procedure of the code translating unit 310 of the simulation apparatus 100 according to the second embodiment will be described.

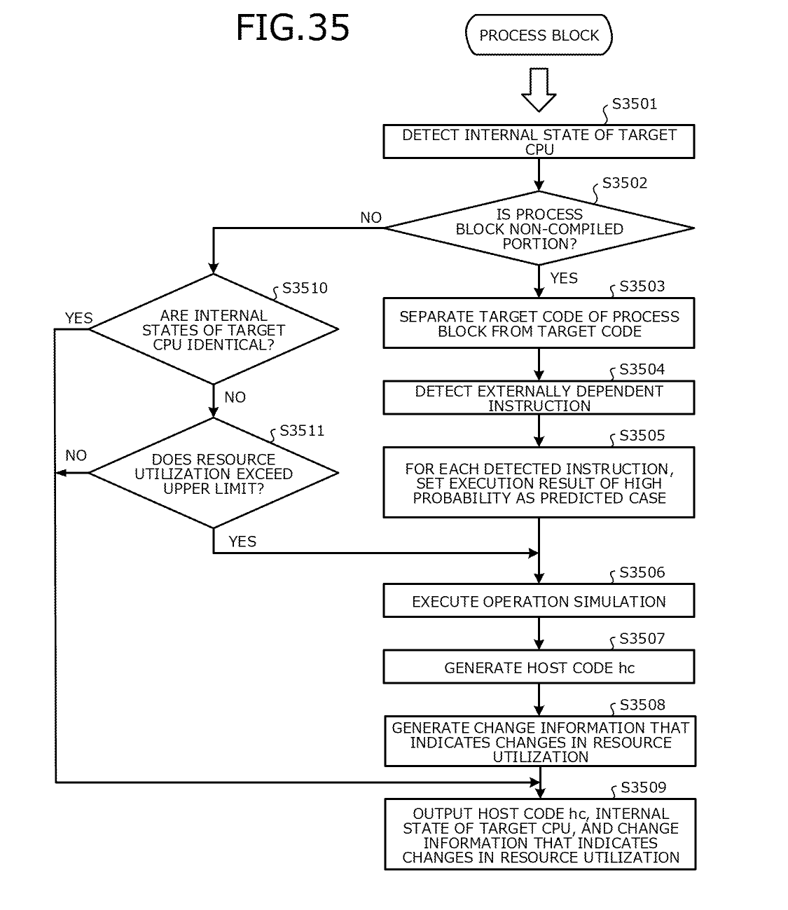

FIG. 35 is a flowchart of an example of the process procedure by the code translating unit 310 of the simulation apparatus 100 according to the second embodiment. In the flowchart depicted in FIG. 35, after transition to a new process block in operation simulation, the code translating unit 310 references the host code list 400 and detects the internal state of the target CPU at the start of execution of the process block (step S3501).

Next, the code translating unit 310 references the host code list 400 and determines whether the process block is a non-compiled portion (step S3502). Here, if the process block is a non-compiled portion (step S3502: YES), the code translating unit 310 separates target code of the process block from the target code of the target program TP (step S3503). Further, the code translating unit 310 associates the block ID of the process block and records into the host code list 400, the internal state of the target CPU at the start of execution of the process block.

The code translating unit 310 detects an externally dependent instruction included in the process block (step S3504). Next, the code translating unit 310, for each of the detected instructions, sets based on the prediction information 350, an execution result of high probability as a predicted case (step S3505).

The code translating unit 310 references the internal state of the target CPU and the timing information 340, and executes operation simulation that assumes the execution results (predicted cases) set as predicted results for the instructions of the process block (step S3506).

Next, the code translating unit 310 generates based on the simulation results of the operation simulation, host code hc that enables calculation of the execution period of the process block (step S3507). The code translating unit 310 generates based on the internal state of the target CPU at the start of execution of the process block and the internal state of the target CPU at the completion of execution of the process block, change information that indicates changes in resource utilization by the target CPU before and after execution of the process block (step S3508).

Next, the code translating unit 310 outputs the generated host code hc, the internal state of the target CPU at the completion of execution of the process block in the operation simulation, and the generated change information that indicates changes in resource utilization by the target CPU before and after execution of the process block (step S3509).

As a result, the host code hc, the internal state of the target CPU at the completion of execution of the process block, and the change information that indicates changes in resource utilization by the target CPU are associated with the block ID of the process block and recorded into the host code list 400.

Further, at step S3502, if the process block has been compiled (step S3502: NO), the code translating unit 310 references the host code list 400 and determines whether the detected internal state of the target CPU is identical to the internal state of the target CPU when the process block was previously subject to processing (step S3510).

Here, if the internal state of the target CPU is not identical (step S3510: NO), the code translating unit 310 determines whether resource utilization by the target CPU in executing the process block exceeds the upper limit (step S3511). Here, if resource utilization by the target CPU exceeds the upper limit (step S3511: YES), the code translating unit 310 transitions to step S3506. The code translating unit 310 associates the block ID of the process block and records into the host code list 400, the internal state of the target CPU at the start of execution of the process block.

On the other hand, if resource utilization by the target CPU does not exceed the upper limit (step S3511: NO), the code translating unit 310 outputs the host code hc generated when the process block was previously subject to processing, the internal state of the target CPU at the completion of execution of the process block in the operation simulation, and the change information that indicates changes in resource utilization by the target CPU (step S3509).

Further, at step S3510, if the internal state of the target CPU is identical (step S3510: YES), the code translating unit 310 outputs the host code hc generated when the process block was previously subject to processing, the internal state of the target CPU at the completion of execution of the process block in the operation simulation, and the change information that indicates changes in resource utilization by the target CPU (step S3509).

As a result, if the internal state of the target CPU is identical or if resource utilization by the target CPU does not exceed the upper limit, the host code hc generated when the process block was previously subject to processing can be reused, enabling repeated generation of the same host code hc for a given block B to be prevented.

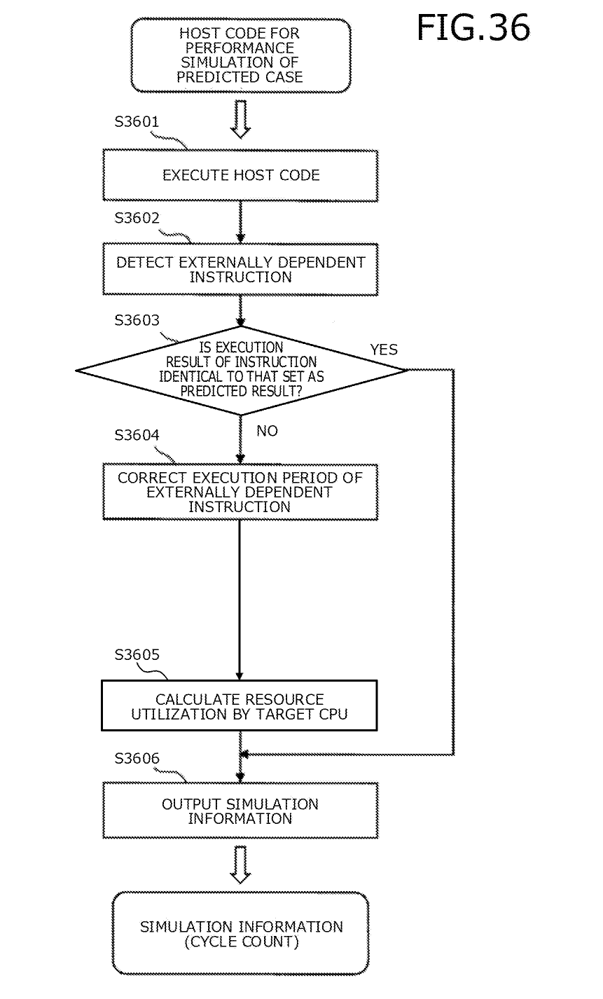

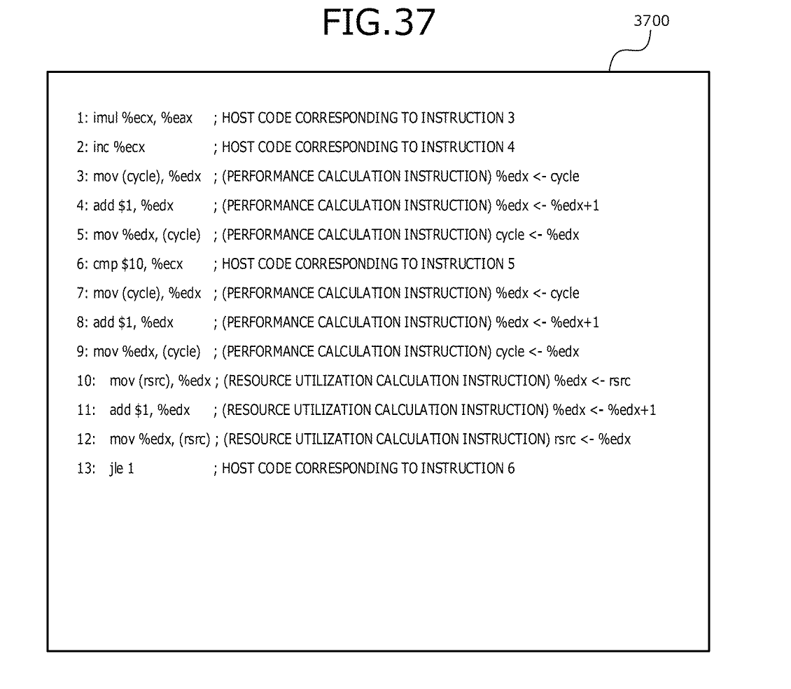

FIG. 36 is a flowchart of an example of the process procedure by the simulation executing unit 320 of the simulation apparatus 100 according to the second embodiment. In FIG. 36, the simulation executing unit 320 references the host code list 400, executes the host code hc generated by the code translating unit 310, and executes performance simulation (step S3601). Next, the simulation executing unit 320, when detecting an externally dependent instruction during execution (step S3602), determines whether the execution result of the instruction is identical to that set as the predicted result (step S3603).

Here, if the execution result of the externally dependent instruction is not identical to the set predicted result (step S3603: NO), the simulation executing unit 320 corrects the execution period of the externally dependent instruction (step S3604). On the other hand, if the execution result of the externally dependent instruction is identical to the set predicted result (step S3603: YES), the simulation executing unit 320 transitions to step S3606 without performing the correction at step S3604.

Next, the simulation executing unit 320 references the host code list 400 (refer to FIG. 33) and calculates resource utilization by the target CPU (step S3605). The simulation information collecting unit 330 outputs the simulation information 360 of the process block (step S3606). Here, if performance simulation for the target CPU has not finished, the simulation information collecting unit 330 outputs information (e.g., block ID) of the next block to be subject to processing.

On the other hand, if performance simulation for the target CPU has been completed, configuration may be such that the simulation information collecting unit 330 outputs the simulation information 360 to include an overall execution period for a case where the target CPU executes the target program TP. As a result, the simulation information 360 (cycle simulation information) of the target CPU executing target program TP can be output.

According to the simulation apparatus 100 of the second embodiment described above, in cases where the internal states of the target CPU are determined to not be identical, whether resource utilization by the target CPU when executing the process block exceeds an upper limit can be determined based on changes in resource utilization by the target CPU before and after execution of the process block. As a result, even when the internal states of the target CPU are not identical, states where the execution period (cycle count) of an instruction does not change can be identified.

Further, according to the simulation apparatus 100, in cases where resource utilization by the target CPU exceeds an upper limit, host code hc for the process block is generated; and in cases where resource utilization by the target CPU does not exceed the upper limit, configuration is such that host code hc for the process block is not generated. According to the simulation apparatus 100, in cases where resource utilization by the target CPU does not exceed the upper limit, the execution period of the process block can be calculated by executing the host code hc generated when the process block was previously subject to processing.

As a result, even when the internal states of the target CPU are not identical, if resource utilization by the target CPU does not exceed the upper limit, the host code hc generated when the process block was previously subject to processing can be reused. As a result, accuracy of the performance simulation can be secured and faster processing can be achieved.

The simulation apparatus 100 according to a third embodiment will be described. In the third embodiment, a case will be described where calculation code for calculating resource utilization by the target CPU is embedded in the host code hc and when the host code hc is executed, resource utilization by the target CPU is calculated. Portions identical to those described in the first and the second embodiments are given the same reference numerals used in the first and the second embodiments, and description thereof will be omitted hereinafter.

Functional units of the simulation apparatus 100 according to the third embodiment will be described. However, the functional configuration of the simulation apparatus 100 according to the third embodiment is the same as the functional configuration example of the simulation apparatus 100 depicted in FIG. 3 and therefore, description thereof will be omitted hereinafter. Further, among the functional units of the simulation apparatus 100 according to the third embodiment, those identical to the functional units described in the first and the second embodiments are given the same reference numerals used in the first and the second embodiments and description thereof is omitted hereinafter.

The prediction simulation executing unit 312, after transition to a new process block, determines whether the process block is a block previously subject to processing. More specifically, for example, the prediction simulation executing unit 312 references the host code list 400 depicted in FIG. 33 and determines whether the block ID of the process block is registered.

If the block ID of the process block is registered, the prediction simulation executing unit 312 determines that the process block is a block previously subject to processing. On the other hand, if the block ID of the process block is not registered, the prediction simulation executing unit 312 determines that the process block is not a block previously subject to processing.

Here, when determining that the process block is not a block previously subject to processing, the prediction simulation executing unit 312 executes operation simulation of the process block, based on the detected internal state of the target CPU at the start of execution of the process block. The code generating unit 313 generates host code hc of the process block, based on the simulation results obtained by the prediction simulation executing unit 312.

Here, the code generating unit 313 generates host code hc that enables calculation of the execution period for a case where the target CPU executes the process block and resource utilization by the target CPU in executing the process block. More specifically, for example, the code generating unit 313 generates the host code hc by embedding timing code tc and resource utilization calculation code rc into the function code fc obtained compiling the code of the process block.

Here, the timing code tc is code for calculating the execution period in a case where the process block is executed. Further, the resource utilization calculation code rc is code for calculating resource utilization by the target CPU in executing the process block.

The code generating unit 313 can generate the resource utilization calculation code rc, based on changes in resource utilization by the target CPU in executed in the process block. A detailed example of the host code hc that includes resource utilization calculation code rc will be described with reference to FIG. 37 hereinafter.

Further, if the process block is determined to be a block previously subject to processing, the prediction simulation executing unit 312 determines whether the detected internal state of the target CPU at the start of execution of the process block is identical to the internal state of the target CPU detected at the start of execution of the block when the block was previously subject to processing.

Here, if the internal state of the target CPU is identical, the prediction simulation executing unit 312 does not execute operation simulation of the process block. Further, the code generating unit 313 does not generate host code hc for the process block. In other words, if the internal state of the target CPU at the start of execution is identical, the host code hc (including the resource utilization calculation code rc) generated when the process block was previously subject to processing can be reused and therefore, the code generating unit 313 does not generate host code hc for the process block.

On the other hand, if the internal state of the target CPU is not identical, the prediction simulation executing unit 312 determines whether resource utilization by the target CPU in executing the process block exceeds the upper limit. Here, if resource utilization by the target CPU does not exceed the upper limit, the prediction simulation executing unit 312 does not execute operation simulation of the process block. Further, the code generating unit 313 does not generate host code hc for the process block.

In other words, if resource utilization by the target CPU does not exceed the upper limit, the execution period (cycle count) of the process block does not change and therefore, the host code hc (including the resource utilization calculation code rc) generated when the process block was previously subject to processing can be reused. As a result, the code generating unit 313 does not generate host code hc for the process block.

Further, if resource utilization by the target CPU does not exceed the upper limit, the code executing unit 321 executes the host code hc (including the resource utilization calculation code rc) generated when the process block was previously subject to processing. In other words, when resource utilization by the target CPU does not exceed the upper limit, the code executing unit 321 executes the generated host code hc (including the resource utilization calculation code rc) of the process block and thereby, calculates the execution period for a case where the target CPU executes the process block.

Resource utilization by the target CPU calculated by executing the host code hc (including the resource utilization calculation code rc), for example, is output as the resource utilization information indicating resource utilization by the target CPU 600.

On the other hand, if resource utilization by the target CPU exceeds the upper limit, the prediction simulation executing unit 312 executes operation simulation for the process block, based on the detected internal state of the target CPU at the start of execution of the process block. The code generating unit 313 generates based on the simulation results obtained by the prediction simulation executing unit 312, host code hc (including the resource utilization calculation code rc) for the process block.

In other words, when resource utilization by the target CPU exceeds the upper limit, the execution period (cycle count) of the process block in the operation simulation changes and therefore, the host code hc (including the resource utilization calculation code rc) generated when the process block was previously subject to processing cannot be reused. Consequently, the code generating unit 313 generates host code hc (including the resource utilization calculation code rc) for the process block.

A detailed example of host code hc that includes resource utilization calculation code rc will be described taking a case where the resource utilization calculation code rc is embedded in the host code 1600 depicted in FIG. 16. Here, the resources of the target CPU are assumed to be one type “rsrc”, and when the process block is executed, “rsrc” is assumed to increase by “1”.

FIG. 37 is a diagram depicting a detailed example of the host code hc. In FIG. 37, host code 3700 is code (x86 instruction) the enables the host CPU to calculate the execution period for a case where the target CPU executes the process block 701 (refer to FIG. 7).

In the host code 3700, lines 10 to 12 are resource utilization calculation instructions (resource utilization calculation code rc) that calculate resource utilization for “rsrc” used by the target CPU. The resource utilization calculation instructions (resource utilization calculation code rc) are instructions that increase resource utilization for “rsrc” by “+1”.

When the target CPU uses two or more types of resources in executing the process block, resource utilization calculation instructions (resource utilization calculation code rc) are generated for each resource type and embedded into the host code hc. For example, in the case of four types of resources, resource utilization calculation instructions (resource utilization calculation code rc) include “12 instructions=3 instructions×4”.

The process procedure of the code translating unit 310 of the simulation apparatus 100 according to the third embodiment will be described.

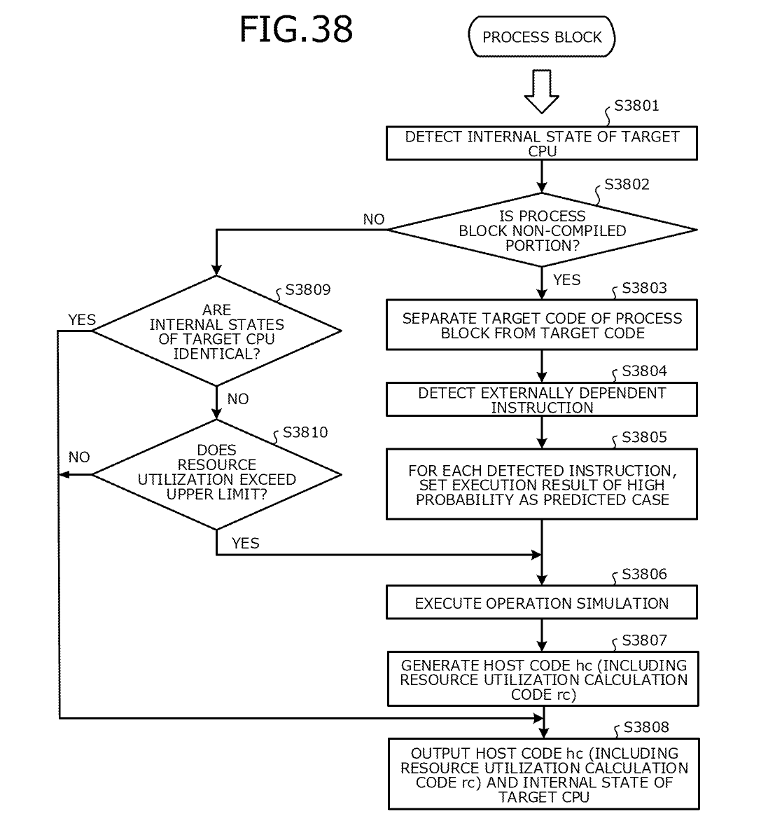

FIG. 38 is a flowchart of an example of the process procedure by the code translating unit 310 of the simulation apparatus 100 according to the third embodiment. In the flowchart depicted in FIG. 38, the code translating unit 310, after transition to a new process block in the operation simulation, references the host code list 400 (refer to FIG. 4) and detects the internal state of the target CPU at the start of execution of the process block (step S3801).

Next, the code translating unit 310 references the host code list 400 and determines whether the process block is a non-compiled portion (step S3802). Here, if the process block is a non-compiled portion (step S3802: YES), the code translating unit 310 separates the target code of the process block from the target code of the target program TP (step S3803). Further, the code translating unit 310 associates the block ID of the process block and records into the host code list 400, the internal state of the target CPU at the start of execution of the process block.

The code translating unit 310 detects an externally dependent instruction included in the process block (step S3804). Next, for each detected instruction, the code translating unit 310 sets based on the prediction information 350, an execution result of a high probability, as a predicted case (step S3805).

The code translating unit 310 references the internal state of the target CPU and the timing information 340, and executes operation simulation assuming the predicted results (predicted cases) for the instructions of the process block (step S3806).

Next, the code translating unit 310 generates based on the simulation results of the operation simulation, the execution period of the process block, and host code hc (including the resource utilization calculation code rc) that enables resource utilization by the target CPU in execution of the process block to be calculated (step S3807).

The code translating unit 310 outputs the generated host code hc (including the resource utilization calculation code rc) and the internal state of the target CPU at the completion of execution of the process block in the operation simulation (step S3808). As a result, the host code hc (including the resource utilization calculation code rc) and the internal state of the target CPU at the completion of execution of the process block are associated with the block ID of the process block and recorded into the host code list 400.

Further, at step S3802, if the process block has been compiled (step S3802: NO), the code translating unit 310 references the host code list 400 and determines whether the detected internal state of the target CPU is identical to the internal state of the target CPU, detected when the process block was previously subject to processing (step S3809).

Here, if the internal state of the target CPU is not identical (step S3809: NO), the code translating unit 310 determines whether resource utilization by the target CPU in executing the process block exceeds the upper limit (step S3810). Here, if resource utilization by the target CPU exceeds the upper limit (step S3810: YES), the code translating unit 310 transitions to step S3806. The code translating unit 310 associates the block ID of the process block and records into the host code list 400, the internal state of the target CPU at the start of execution of the process block.

On the other hand, if resource utilization by the target CPU does not exceed the upper limit (step S3810: NO), the code translating unit 310 outputs the host code hc (including the resource utilization calculation code rc) generated when the process block was previously subject to processing and the internal state of the target CPU at the completion of execution of the process block in the operation simulation (step S3808).

Further, at step S3809, if the internal state of the target CPU is identical (step S3809: YES), the code translating unit 310 outputs the host code hc (including the resource utilization calculation code rc) generated when the process block was previously subject to processing and the internal state of the target CPU at the completion of execution of the process block in the operation simulation (step S3808).

The process procedure of the simulation executing unit 320 of the simulation apparatus 100 according to the third embodiment is identical to the process procedure (depicted in FIG. 28) of the simulation executing unit 320 and therefore, further description thereof is omitted herein.

According to the simulation apparatus 100 of the third embodiment described, host code hc can be generated that can calculate the execution period for a case where the target CPU executes the process block and resource utilization by the target CPU in executing the process block.

As a result, at the generation process of the host code hc, resource utilization calculation code rc that enables calculation of resource utilization by the target CPU in executing the process block can be included, enabling resource utilization by the target CPU to be obtained by an execution of the host code hc.

The simulation apparatus 100 according to a fourth embodiment will be described. Portions identical to those described in the first to the third embodiments are given the same reference numerals used in the first to the third embodiments, and description thereof will be omitted hereinafter.

Here, even when resource utilization by the target CPU exceeds the upper limit, there are cases where the host code hc of the process block can be reused and the obtained execution period (cycle count) of the process block can be corrected by a simple calculation. Whether the execution period of the process block is correctable depends on the module that the target CPU has for realizing out-of-order execution.

More specifically, whether the execution period of the process block is correctable depends on whether the period of time from when the resources of the target CPU are unavailable until the resources become available can be obtained simply. Taking the target CPU 600 depicted in FIG. 6 as an example, the period of time from when the instruction queue 602 or the reorder buffer 607 becomes full until the instruction queue 602 or the reorder buffer 607 becomes empty can be obtained relatively easily.

For example, in the case of the instruction queue 602, by checking the time when an instruction under execution by an execution unit (the ALUs 603, 604, the load/store unit 605, the branching unit 606) is completed, it can be determined when the instruction queue 602 will become empty. On the other hand, the period of time from when execution units are unavailable until the execution units become available cannot be determined easily since dependency relations of the instructions have to be checked.

Thus, in the fourth embodiment, a simulation method will be described where only when an upper limit for a resource enabling correction of the execution period of the process block is exceeded, the host code hc of the process block is reused, and the execution period error caused by the resource upper limit being exceeded is corrected.

Functional units of the simulation apparatus 100 according to the fourth embodiment will be described. However, the functional configuration of the simulation apparatus 100 according to the fourth embodiment is the same as the functional configuration of the simulation apparatus 100 depicted in FIG. 3 and therefore, description thereof will be omitted herein. Further, among the functional units of the simulation apparatus 100 according to the fourth embodiment, those identical to the functional units described in the first to third embodiments are given the same reference numerals and description thereof is omitted hereinafter.

The prediction simulation executing unit 312 determines whether resource utilization by the target CPU in executing the process block exceeds the upper limit. If resource utilization by the target CPU exceeds the upper limit, the prediction simulation executing unit 312 further determines among the resources of the target CPU, whether resource utilization of a predetermined resource by the target CPU in executing the process block exceeds an upper limit.

Here, the predetermined resource is a resource that when the amount of use thereof exceeds an upper limit, the execution period of the process block obtained by reusing the host code hc cannot be corrected by a simple calculation. The predetermined resource, for example, is an execution unit the target CPU 600.

Therefore, if utilization of the predetermined resource exceeds the upper limit, the prediction simulation executing unit 312 executes operation simulation of the process block, based on the detected internal state of the target CPU at the start of execution of the process block. The code generating unit 313 generates based on the simulation results of the prediction simulation executing unit 312, host code hc for the process block.

In other words, when resource utilization of the predetermined resource exceeds the upper limit, the execution period of the process block obtained by reusing the host code hc cannot be corrected simply and therefore, the host code hc generated when the process block was previously subject to processing cannot be reused. Consequently, the code generating unit 313 generates host code hc for the process block.

On the other hand, if resource utilization of the predetermined resource does not exceed the upper limit, the prediction simulation executing unit 312 does not execute operation simulation of the process block. Further, the code generating unit 313 does not generate host code hc for the process block.

In other words, when resource utilization of the predetermined resource does not exceed upper limit, the execution period of the process block obtained by reusing the host code hc can be corrected easily and therefore, the host code hc generated when the process block was previously subject to processing can be reused. Consequently, the code generating unit 313 does not generate host code hc for the process block.

Further, if resource utilization of the predetermined resource does not exceed the upper limit, the code executing unit 321 executes the host code hc generated when the process block was previously subject to processing. The code executing unit 321 further performs correction of adding to the execution period of the process block obtained by reusing the host code hc, a value of delay caused by the upper limit of resource utilization for a resource other than the predetermined resource being exceeded.

A resource other than the predetermined resource is a resource that even when utilization thereof exceeds an upper limit, the execution period of the process block obtained by reusing the host code hc can be corrected easily. A resource other than the predetermined resource, for example, is the instruction queue 602, the reorder buffer 607, etc. of the target CPU 600.

The value of delay caused by the upper limit being exceeded, for example, can be obtained from the reference values (included in the timing information 340 (refer to FIG. 3)) of the execution periods when the instructions of the target code are executed and the execution periods of instructions under execution (unfinished) by an execution unit.

Here, an example of calculation of the value of delay caused by the upper limit being exceeded will be described. Taking the target code 3100 depicted in FIG. 31 as an example, as depicted in FIG. 32, when the process block (block B2) is executed one time, the instruction count of the instruction queue 602 increased by “1”.

Therefore, after the second execution of the process block (block B2), the instruction queue 602 becomes full, and the start of the third execution of the process block (block B2) becomes delayed. In the third execution of the process block (block B2), instruction 4(mls r3,r1,r3,r0) is under execution by an execution unit.

For example, assuming that the reference value of the execution period when instruction 4 is executed is “4 cycles” and the execution period of instruction 4 during execution by the execution unit is “1 cycle”, three more cycles are needed to complete execution of instruction 4. In other words, the start of the third execution of the process block (block B2) is delayed by 3 cycles.

In this case, the code executing unit 321 calculates the value of the delay caused by the upper limit for the instruction queue 602 of the target CPU 600 being exceeded to be “3 cycles”. The code executing unit 321 adds the value of delay “3 cycles” to the execution period of the process block (block B2) obtained by executing the host code hc and thereby, corrects the execution period of the process block (block B2).

Various process procedures of the simulation apparatus 100 according to the fourth embodiment will be described. First, the process procedure of the code translating unit 310 of the simulation apparatus 100 according to the fourth embodiment will be described.

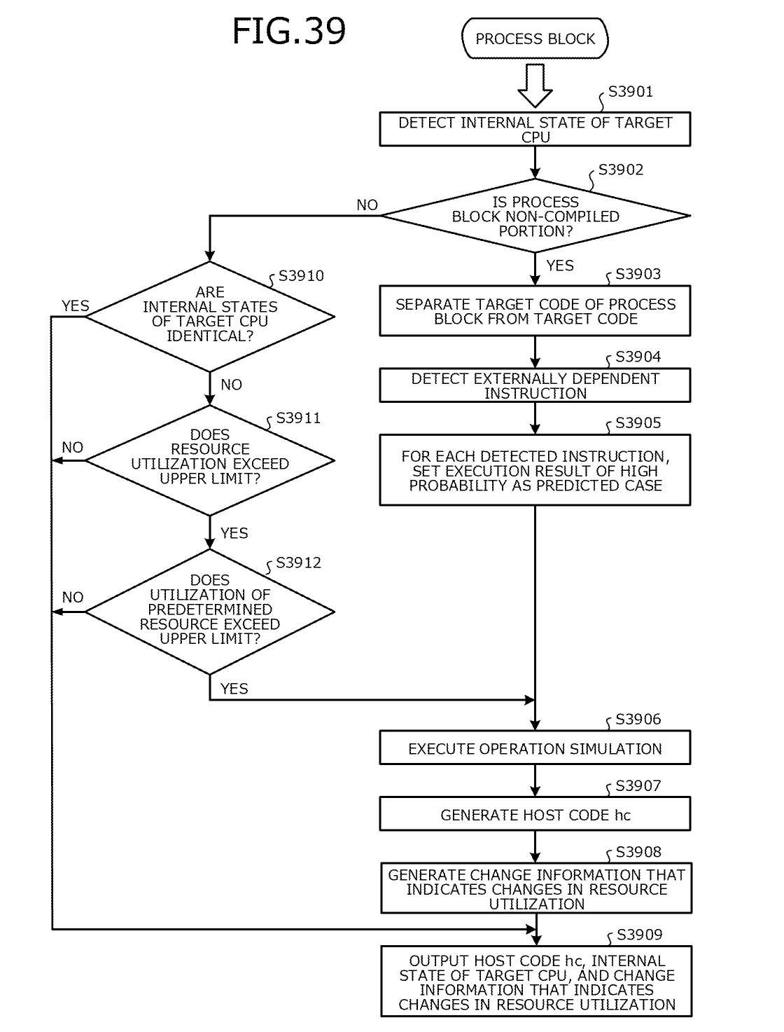

FIG. 39 is a flowchart of an example of the process procedure by the code translating unit 310 of the simulation apparatus 100 according to the fourth embodiment. In the flowchart depicted in FIG. 39, after transition to a new process block in the operation simulation, the code translating unit 310 references the host code list 400 (refer to FIG. 33) and detects the internal state of the target CPU at the start of execution of the process block (step S3901).

The code translating unit 310 references the host code list 400 and determines whether the process block is a non-compiled portion (step S3902). Here, if the process block is a non-compiled portion (step S3902: YES), the code translating unit 310 separates target code of the process block from the target code of the target program TP (step S3903). The code translating unit 310 associates a block ID of the process block and records the internal state of the target CPU at the start of execution of the process block into the host code list 400.

The code translating unit 310 detects an externally dependent instruction included in the process block (step S3904). For each detected instruction, the code translating unit 310 sets based on the prediction information 350, an execution result of high probability as a predicted case (step S3905).

The code translating unit 310 references the internal state of the target CPU and the timing information 340, and executes operation simulation that assumes the execution results (predicted cases) set as predicted results for the instructions of the process block (step S3906).

Next, the code translating unit 310 generates based on simulation results of the operation simulation, host code hc that enables calculation of the execution period of the process block (step S3907). The code translating unit 310 generates based on the internal state of the target CPU at the start of execution of the process block and the internal state of the target CPU at the completion of execution of the process block, change information that indicates changes in resource utilization by the target CPU before and after execution of the process block (step S3908).

Next, the code translating unit 310 outputs the generated host code hc, the internal state of the target CPU at the completion of execution of the process block in the operation simulation, and the generated change information indicating changes in resource utilization by the target CPU before and after execution of the process block (step S3909).

As a result, the host code hc, the internal state of the target CPU at the completion of execution of the process block, and the change information indicating changes in resource utilization by the target CPU are associated with the block ID of the process block and recorded into the host code list 400.

Further, at step S3902, if the process block has been compiled (step S3902: NO), the code translating unit 310 references the host code list 400, and determines whether the detected internal state of the target CPU is identical to the internal state of the target CPU, detected when the process block was previously subject to processing (step S3910).

Here, if the internal state of the target CPU is not identical (step S3910: NO), the code translating unit 310 determines whether resource utilization by the target CPU in executing the process block exceeds the upper limit (step S3911).

Here, if resource utilization by the target CPU exceeds the upper limit (step S3911: YES), the code translating unit 310 determines whether resource utilization of a predetermined resource among the resources of the target CPU used in executing the process block exceeds an upper limit (step S3912).

Here, if resource utilization of the predetermined resource exceeds the upper limit (step S3912: YES), the code translating unit 310 transitions to step S3906. The code translating unit 310 associates the block ID of the process block and records the internal state of the target CPU at the start of execution of the process block into the host code list 400.

On the other hand, if resource utilization of the predetermined resource does not exceed the upper limit (step S3912: NO), the code translating unit 310 outputs the host code hc generated when the process block was previously subject to processing, the internal state of the target CPU at the completion of execution of the process block in the operation simulation, and the change information indicating changes in resource utilization by the target CPU (step S3909).

Further, at step S3911, if resource utilization by the target CPU does not exceed the upper limit (step S3911: NO), the code translating unit 310 outputs the host code hc generated when the process block was previously subject to processing, the internal state of the target CPU at the completion of execution of the process block in the operation simulation, and the change information indicating changes in resource utilization by the target CPU (step S3909).

Further, at step S3910, if the internal state of the target CPU is identical (step S3910: YES), the code translating unit 310 outputs the host code hc generated when the process block was previously subject to processing, the internal state of the target CPU at the completion of execution of the process block in the operation simulation, and the change information indicating changes in resource utilization by the target CPU (step S3909).

As a result, when the internal state of the target CPU is identical, or when resource utilization of the predetermined resource by target CPU does not exceed an upper limit, the host code hc generated when the process block was previously subject to processing can be reused and repeated generation of the same host code hc for a given block B can be prevented.

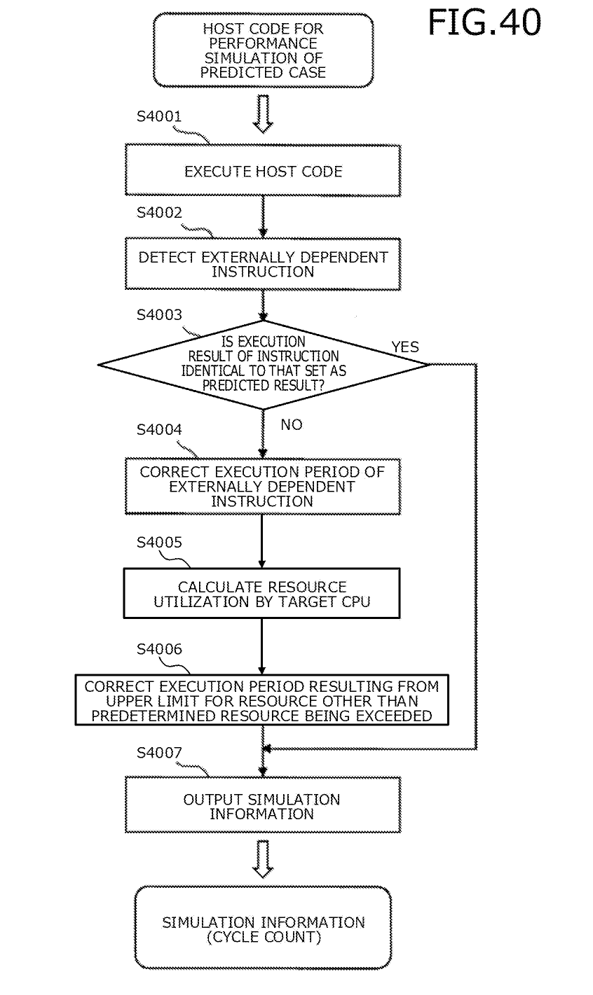

FIG. 40 is a flowchart of an example of the process procedure by the simulation executing unit 320 of the simulation apparatus 100 according to the fourth embodiment. In FIG. 40, the simulation executing unit 320 references the host code list 400 (refer to FIG. 33, executes the host code hc generated by the code translating unit 310, and executes performance simulation (step S4001). Next, the simulation executing unit 320, when detecting an externally dependent instruction during execution (step S4002), determines whether the execution result of the instruction is identical to that set as the predicted result (step S4003).

Here, if the execution result of the externally dependent instruction is not identical to the set predicted result (step S4003: NO), the simulation executing unit 320 corrects the execution period of the externally dependent instruction (step S4004). On the other hand, if the execution result of the externally dependent instruction is identical to the set predicted result (step S4003: YES), the simulation executing unit 320 transitions to step S4007 without performing the correction at step S4004.

Next, the simulation executing unit 320 references the host code list 400 (refer to FIG. 33) and calculates resource utilization by the target CPU (step S4005). The simulation executing unit 320 performs correction of the execution period resulting from the upper limit for a resource other than the predetermined resource being exceeded (step S4006).

The simulation information collecting unit 330 outputs the simulation information 360 of the process block (step S4007). Here, if performance simulation for the target CPU has not finished, the simulation information collecting unit 330 outputs information (e.g., block ID) of the next block to be subject to processing.

On the other hand, if performance simulation for the target CPU has been completed, configuration may be such that the simulation information collecting unit 330 outputs the simulation information 360 to include an overall execution period for a case where the target CPU executes the target program TP. As a result, the simulation information 360 (cycle simulation information) of the target CPU executing target program TP can be output.

In the description above, although an example has been given where resource utilization calculation code rc is not embedded in host code hc, as described in the third embodiment, resource utilization calculation code rc may be embedded in host code hc.

According to the simulation apparatus 100 of the fourth embodiment described, whether utilization of a predetermined resource among resources used by the target CPU in executing the process block exceeds an upper limit can be determined. As a result, whether the execution period error of the process block caused by the resource upper limit being exceeded is correctable can be determined.

Further, according to the simulation apparatus 100, configuration is enabled such that when resource utilization of the predetermined resource exceeds the upper limit, host code hc is generated, and when resource utilization of the predetermined resource does not exceed the upper limit, host code hc is not generated. As a result, even when resource utilization by the target CPU exceeds the upper limit, if the execution period of the process block is correctable, the host code hc generated when the process block was previously subject to processing can be reused, enabling faster performance simulation.

Further, according to the simulation apparatus 100, when resource utilization of the predetermined resource does not exceed the upper limit, the host code hc generated when the process block was previously subject to processing can be executed. Further, according to the simulation apparatus 100, correction can be performed by adding to the execution period of the process block obtained by executing the host code hc, a value of delay caused by the upper limit of resource utilization for a resource other than the predetermined resource being exceeded. As a result, the execution period error of the process block caused by the resource upper limit being exceeded by the target CPU is corrected, enabling accuracy of the performance simulation to be secured.

The simulation method described in the present embodiment may be implemented by executing a prepared program on a computer such as a personal computer and a workstation. The program is stored on a non-transitory, computer-readable recording medium such as a hard disk, a flexible disk, a CD-ROM, an MO, and a DVD, read out from the computer-readable medium, and executed by the computer. The program may be distributed through a network such as the Internet.

According to one aspect of the present disclosure, an effect is achieved in that the accuracy of processor performance estimation can be improved.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A simulation apparatus comprising:
a generating circuit configured to detect an internal state of a processor at a start of execution of a process block, when among blocks obtained by dividing code of a program executed by the processor that performs out-of-order execution, processing transitions to the process block in a simulation simulating operation in a case where the processor executes the program, the generating circuit being further configured to generate host code that enables calculation of a block execution period for the case where the processor executes the process block, the generating circuit generating the host code by executing the simulation of the process block based on the detected internal state of the processor; and
an executing circuit configured to calculate the block execution period by executing the host code generated by the generating circuit.

2. The simulation apparatus according to claim 1, wherein
the generating circuit, when the processing transitions to the process block, determines whether the process block was previously subject to processing and when determining that the process block was previously subject to processing, determines whether the detected internal state of the processor is identical to an internal state of the processor detected when the process block was previously subject to processing and when determining that the detected internal state of the processor is not identical, generates the host code, and when determining that the detected internal state of the processor is identical, refrains from generating the host code.

3. The simulation apparatus according to claim 2, wherein
the executing circuit, when the generating circuit determines that the detected internal state of the processor is identical, calculates the block execution period by executing the host code generated when the process block was previously subject to processing.

4. The simulation apparatus according to claim 3, wherein
the generating circuit detects as the internal state of the processor, a state of a module that the processor has for out-of-order execution.

5. The simulation apparatus according to claim 4, wherein
the generating circuit executes the simulation of the process block based on the detected internal state of the processor, by setting as a predicted result, an execution result for an externally dependent instruction that among instructions included in the process block, has a variable execution period dependent on a state of a hardware resource accessed by the processor when the externally dependent instruction is executed.

6. The simulation apparatus according to claim 5, wherein
the executing circuit, when in an execution result of the host code, an execution result of the externally dependent instruction differs from the predicted result, corrects the execution period of the externally dependent instruction in a case of the predicted result and calculates the block execution period, the executing circuit correcting the execution period by a correction value obtained using a predetermined delay period of the externally dependent instruction and execution periods of instructions executed before and after the externally dependent instruction.

7. The simulation apparatus according to claim 6, wherein
the executing circuit, when an execution period of a subsequent instruction executed after the externally dependent instruction does not exceed a delay period added to the externally dependent instruction, subtracts from the delay period of the externally dependent instruction as the correction value, the execution period of the subsequent instruction.

8. The simulation apparatus according to claim 1, wherein
the generating circuit embeds in function code that is compiled code of the process block, timing code that calculates the block execution period.

9. The simulation apparatus according to claim 2, wherein
the generating circuit, when determining that the detected internal state of the processor is not identical, determines whether utilization of a resource by the processor in executing the process block exceeds a upper limit and when determining that the utilization exceeds the upper limit, generates the host code, and when determining that the utilization does not exceed the upper limit, refrains from generating the host code.

10. The simulation apparatus according to claim 9, wherein
the executing circuit, when the generating circuit determines that the utilization does not exceed the upper limit, calculates the block execution period by executing the host code generated when the process block was previously subject to processing.

11. The simulation apparatus according to claim 9, wherein
the generating circuit generates based on the detected internal state of the processor at the start of execution of the process block and an internal state of the processor at completion of the execution of the process block, change information indicating change in the utilization before and after execution of the process block, and
the generating circuit, when determining that the detected internal state of the processor is not identical, determines whether the utilization based on the generated change information exceeds the upper limit.

12. The simulation apparatus according to claim 9, wherein
the generating circuit generates the host code that enables calculation of the block execution period and the utilization of the resource by the processor in executing the process block.

13. The simulation apparatus according to claim 12, wherein
the generating circuit embeds in function code that is compiled code of the process block, timing code that calculates the block execution period and resource utilization calculation code that calculates the utilization of the resource by the processor in executing the process block.

14. The simulation apparatus according to claim 9, wherein
the generating circuit, when determining that the utilization exceeds the upper limit, determines whether among resources used by the processor in executing the process block, utilization of a predetermined resource exceeds the upper limit and when determining that the utilization of the predetermined resource exceeds the upper limit, generates the host code, and when determining that the utilization of the predetermined resource does not exceed the upper limit, refrains from generating the host code.

15. The simulation apparatus according to claim 14, wherein
the executing circuit, when the generating circuit determines that the utilization of the predetermined resource does not exceed the upper limit, calculates the block execution period by executing the host code generated when the process block was previously subject to processing and performs correction by adding to the calculated execution period, a value of delay caused by a resource other than the predetermined resource exceeding the upper limit.

16. A simulation method comprising:
detecting an internal state of a processor at a start of execution of a process block, when among blocks obtained by dividing code of a program executed by the processor that performs out-of-order execution, processing transitions to the process block in a simulation simulating operation in a case where the processor executes the program;
generating host code that enables calculation of a block execution period for the case where the processor executes the process block, the host code being generated by executing the simulation of the process block based on the detected internal state of the processor; and
calculating the block execution period by executing the generated host code, wherein
the simulation method is executed by a computer.

17. A non-transitory, computer-readable recording medium storing therein a simulation program that causes a computer to execute a process comprising:
detecting an internal state of a processor at a start of execution of a process block, when among blocks obtained by dividing code of a program executed by the processor that performs out-of-order execution, processing transitions to the process block in a simulation simulating operation in a case where the processor executes the program;
generating host code that enables calculation of a block execution period for the case where the processor executes the process block, the host code being generated by executing the simulation of the process block based on the detected internal state of the processor; and
calculating the block execution period by executing the generated host code.
